(19) United States
(12) Patent Application Publication
(10) Pub. No.: US 2024/0361725 A1
(43) Pub. Date: Oct. 31, 2024

(54) PROCESS CARTRIDGE AND ELECTROPHOTOGRAPHIC APPARATUS

(71) Applicant: CANON KABUSHIKI KAISHA, Tokyo (JP)

(72) Inventors: KANAME WATARIGUCHI, Tokyo (JP); TSUTOMU NISHIDA, Shizuoka (JP); CHIHARU AKIYAMA, Shizuoka (JP)

(21) Appl. No.: 18/646,545

(22) Filed: Apr. 25, 2024

(30) Foreign Application Priority Data
Apr. 28, 2023 (JP) 2023-075129
Oct. 26, 2023 (JP) 2023-184117
Feb. 26, 2024 (JP) 2024-026847

(51) Int. Cl. G03G 21/18; G03G 5/147

(52) U.S. Cl. CPC G03G 21/1814; G03G 5/14756; G03G 21/1857; G03G 2215/00957

(57) ABSTRACT

Provided is a process cartridge being detachably attachable onto a main body of an electrophotographic apparatus. The process cartridge includes an electrophotographic photosensitive member, a developing roller, and a toner-supplying roller. The developing roller and the toner-supplying roller are configured to be opposite to each other at a contact position between the developing roller and the toner-supplying roller, and to be rotated while R represented by the following formula (E1) satisfies 1.2≤R≤1.5: R=V_{RS}/V_{D} Formula (E1) (in the formula (E1), V_{RS} represents an absolute value of a peripheral velocity [m/s] of the toner-suppling roller, and V_{D} represents an absolute value of a peripheral velocity [m/s] of the developing roller). The electrophotographic photosensitive member includes a surface layer containing a polycarbonate resin including a structural unit represented by the formula (A1).

### BACKGROUND

### Field of the Disclosure

The present disclosure relates to a process cartridge and an electrophotographic apparatus each including an electrophotographic photosensitive member.

### Description of the Related Art

In recent years, the extension of the service life of an electrophotographic apparatus has been strengthened. However, in an electrophotographic process, the extension of the service life is liable to cause various adverse effects. Thus, various efforts have been made to counter various adverse effects associated with the extension of the service life.

As one of the above-mentioned adverse defects, there is given a problem in that the amount of toner supplied from a developing roller to be mounted on the electrophotographic apparatus to an electrophotographic photosensitive member (hereinafter sometimes simply referred to as “photosensitive member”) becomes unstable through the repeated use of the apparatus. On one hand, when the amount of the toner that has coated the top of the developing roller is excessive, the supply of the toner to the photosensitive member becomes excessive, and hence background fogging, in which a non-image portion that is originally not supposed to be supplied with the toner is developed, occurs. On the other hand, when the amount of the toner that has coated the top of the developing roller is insufficient, the followability of the toner that has coated the top of the developing roller with respect to a solid image is reduced, and hence a developing ghost, in which the supply amount of the toner to the photosensitive member becomes smaller than its original amount to cause a reverse image, occurs.

To solve those adverse effects, the configuration of the developing roller and a toner-supplying roller that supplies the toner to the developing roller has been devised.

In Japanese Patent Application Laid-Open No. 2011-59167, there is a description of a configuration in which the rotation directions of the developing roller (developer-carrying member) and the toner-supplying roller (toner-recovering and supplying member) are opposite to each other in a portion at which the respective members are rubbed against each other (hereinafter referred to as “counter configuration”). In Japanese Patent Application Laid-Open No. 2011-59167, the above-mentioned background fogging and developing ghost are suppressed by setting the recovery ratio of residual toner on the developing roller by the toner-supplying roller and the value of a charging amount per mass of toner to appropriate ranges under the above-mentioned counter configuration.

In Japanese Patent Application Laid-Open No. 2009-271418, there is a description of a configuration in which a ratio V_{S}/V_{D} (hereinafter referred to as “R”) of a peripheral velocity Vs (absolute value) of the toner-supplying roller to a peripheral velocity V_{D} (absolute value) of the developing roller is 0.8 to 1.5. In Japanese Patent Application Laid-Open No. 2009-271418, on one hand, the R is set to 0.8 or more under the counter configuration to ensure a coat amount on the developing roller, to thereby suppress the occurrence of a developing ghost. In addition, on the other hand, the R is set to 1.5 or less to alleviate a stress on the toner, to thereby suppress toner deterioration in the case of using toner having small particle diameter.

In each of the technologies as described in Japanese Patent Application Laid-Open No. 2011-59167 and Japanese Patent Application Laid-Open No. 2009-271418, the average per round of the developing roller of the amount of the toner supplied from the developing roller to the photosensitive member at the time of the repeated use of the electrophotographic apparatus can be stabilized.

According to investigations made by the inventors of the present disclosure, in each of the technologies as described in Japanese Patent Application Laid-Open No. 2011-59167 and Japanese Patent Application Laid-Open No. 2009-271418, banding may occur at the time of the repeated use of the electrophotographic apparatus.

### SUMMARY OF THE DISCLOSURE

Thus, an object of the present disclosure is to provide a process cartridge capable of suppressing background fogging and a developing ghost and further suppressing the occurrence of banding at the time of repeated use.

The above-mentioned object is achieved by the disclosure to be described below. That is, according to one aspect of the present disclosure, there is provided a process cartridge being detachably attachable onto a main body of an electrophotographic apparatus, the process cartridge including: an electrophotographic photosensitive member; a developing roller configured to develop an electrostatic latent image formed on a surface of the electrophotographic photosensitive member; and a toner-supplying roller arranged in contact with the developing roller and configured to supply toner to the developing roller, wherein the developing roller and the toner-supplying roller are configured so that a movement direction of a surface of the developing roller and a movement direction of a surface of the toner-supplying roller at a time of operation are opposite to each other at a contact position between the developing roller and the toner-supplying roller, and the developing roller and the toner-supplying roller are rotated while R represented by the following formula (E1) satisfies 1.2≤R≤1.5:

R=V_{RS}/V_{D} (E1)

in the formula (E1), V_{RS} represents an absolute value of a peripheral velocity [m/s] of the toner-suppling roller, and V_{D} represents an absolute value of a peripheral velocity [m/s] of the developing roller, and wherein the electrophotographic photosensitive member includes a surface layer containing a polycarbonate resin including a structural unit represented by the following formula (A1):

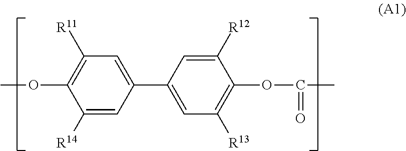

in the formula (A1), R¹¹ to R¹⁴ each independently represent a hydrogen atom or a methyl group.

In addition, according to another aspect of the present disclosure, there is provided an electrophotographic apparatus including the above-mentioned process cartridge.

Further features of the present disclosure will become apparent from the following description of exemplary embodiments with reference to the attached drawings.

### BRIEF DESCRIPTION OF THE DRAWINGS

FIG. 1 is a schematic sectional view of a process cartridge according to one embodiment of the present disclosure.

FIG. 2 is a schematic view for illustrating the drive mechanism of a toner-supplying roller and a developing roller according to one embodiment of the present disclosure.

FIG. 3 is a schematic view for illustrating the drive mechanism of a toner-supplying roller and a developing roller according to one embodiment of the present disclosure.

FIG. 4 is a schematic view for illustrating an image for evaluating a developing ghost.

### DESCRIPTION OF THE EMBODIMENTS

The present disclosure is described in detail below by way of exemplary embodiments.

The present disclosure relates to a process cartridge being detachably attachable onto a main body of an electrophotographic apparatus, the process cartridge including: an electrophotographic photosensitive member; a developing roller configured to develop an electrostatic latent image formed on a surface of the electrophotographic photosensitive member; and a toner-supplying roller arranged in contact with the developing roller and configured to supply toner to the developing roller, wherein the developing roller and the toner-supplying roller are configured so that a movement direction of a surface of the developing roller and a movement direction of a surface of the toner-supplying roller at a time of operation are opposite to each other at a contact position between the developing roller and the toner-supplying roller, and the developing roller and the toner-supplying roller are rotated while R represented by the following formula (E1) satisfies 1.2≤R≤1.5:

R=V_{RS}/V_{D} (E1)

in the formula (E1), V_{RS} represents an absolute value of a peripheral velocity [m/s] of the toner-suppling roller, and V_{D} represents an absolute value of a peripheral velocity [m/s] of the developing roller, and wherein the electrophotographic photosensitive member includes a surface layer containing a polycarbonate resin including a structural unit represented by the following formula (A1):

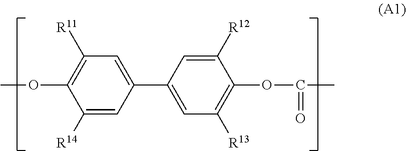

in the formula (A1), R¹¹ to R¹⁴ each independently represent a hydrogen atom or a methyl group.

The present disclosure also relates to an electrophotographic apparatus including the above-mentioned process cartridge.

In the related art, the average per round of the developing roller of the amount of the toner supplied from the developing roller to the photosensitive member at the time of repeated use can be stabilized. In contrast, as a result of the investigations made by the inventors of the present disclosure, it has been found that the supply amount of the toner may abruptly become unstable in the related art.

In particular, in the case where the developing roller and the toner-supplying roller are set to have a counter configuration, and the R is set to a value larger than 1, rubbing between the developing roller and the toner-supplying roller at a contact portion therebetween through intermediation of the toner is liable to cause the supply amount of the toner to abruptly become unstable. For example, a frictional force between the developing roller and the toner-supplying roller is abruptly fluctuated by the deterioration of the toner due to its repeated use, and uncertainties, such as external foreign matter and an external environment, and the abrupt fluctuation causes stick-slip. As a result, a coat amount on the developing roller is locally increased or decreased, and banding, in which such local increase or decrease of the coat amount appears as a streak-like uneven image, occurs. Thus, the related art has involved a problem in that the background fogging and the developing ghost are suppressed, and the occurrence of the banding are further suppressed at the time of repeated use.

In view of the foregoing, the inventors of the present disclosure have investigated the combination of the configuration of the developing roller and the toner-supplying roller, and a photosensitive member surface material, and have optimized the combination. As a result, the inventors have found that to solve the above-mentioned problem, it is only required that the configuration of the developing roller and the toner-supplying roller, and the photosensitive member surface material be each designed as described below, and be combined with each other.

### <Configuration of Developing Roller and Toner-supplying Roller>

In the present disclosure, the developing roller and the toner-supplying roller are configured so that the movement direction of the surface of the developing roller and the movement direction of the surface of the toner-supplying roller at the time of operation are opposite to each other at the contact position between the developing roller and the toner-supplying roller. In addition, the developing roller and the toner-supplying roller are further configured to be rotated while R represented by the following formula (E1) satisfies 1.2≤R≤1.5:

R=V_{RS}/V_{D} (E1)

in the formula (E1), V_{RS} represents the absolute value of the peripheral velocity [m/s] of the toner-suppling roller, and V_{D} represents the absolute value of the peripheral velocity [m/s] of the developing roller.

On one hand, because of the counter configuration of the toner-supplying roller with respect to the developing roller, the toner remaining on the developing roller after development from the developing roller to the photosensitive member is performed is forcefully scraped off by the toner-supplying roller. As a result, the amount of the toner that coats the top of the developing roller in each development process is stabilized without being influenced by the amount of the toner remaining in the previous development process. Thus, the average per round of the developing roller of the amount of the toner supplied from the developing roller to the photosensitive member at the time of repeated use can be stabilized.

On the other hand, because of the configuration in which the R satisfies 1.2≤R≤1.5, an appropriate amount of the toner can be stably supplied from the toner-supplying roller to the developing roller. As a result, both the background fogging, which occurs when the coat amount on the developing roller is excessive, and the developing ghost, which occurs when the coat amount on the developing roller is insufficient, can be suppressed.

### <Photosensitive Member Surface Material>

In the present disclosure, the photosensitive member includes a surface layer containing a polycarbonate resin including a structural unit represented by the following formula (A1):

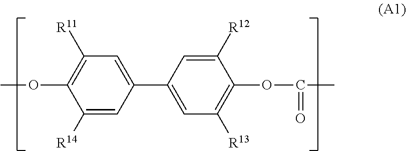

in the formula (A1), R¹¹ to R¹⁴ each independently represent a hydrogen atom or a methyl group.

The reason why the photosensitive member to be used in the present disclosure needs to include the surface layer containing the polycarbonate resin including the structural unit represented by the formula (A1) is described below.

As described in the section <Configuration of Developing Roller and Toner-supplying Roller>, when the configuration of the developing roller and the toner-supplying roller is devised, the average per round of the developing roller of the amount of the toner supplied from the developing roller to the photosensitive member at the time of repeated use can be stabilized. However, when the developing roller and the toner-supplying roller are set to have a counter configuration, and the R is set to a value larger than 1, the rubbing between the developing roller and the toner-supplying roller at the contact portion through intermediation of the toner is liable to cause the supply amount of the toner to abruptly become unstable. For example, the frictional force between the developing roller and the toner-supplying roller is abruptly fluctuated by the deterioration of the toner due to its repeated use, and the uncertainties, such as the external foreign matter and the external environment, and the abrupt fluctuation causes the stick-slip. As a result, the coat amount on the developing roller is locally increased or decreased, and the banding, in which such local increase or decrease of the coat amount appears as the streak-like uneven image, occurs. In view of the foregoing, in the present disclosure, the occurrence of the banding at the time of the repeated use is suppressed by using the polycarbonate resin including the structural unit represented by the formula (A1) as the photosensitive member surface material.

The inventors of the present disclosure have presumed the mechanism via which the occurrence of the banding at the time of the repeated use is suppressed by using the polycarbonate resin including the structural unit represented by the formula (A1) as the photosensitive member surface material to be described below.

In the repeated use, the polycarbonate resin in the surface of the photosensitive member is generally gradually scraped by rubbing against, for example, members that are brought into contact with the photosensitive member, such as a cleaning blade, a charging roller, a developing roller, paper, or a transfer belt. When the repeated use proceeds to some degree, the scraped polycarbonate resin becomes powder (hereinafter referred to as “scraped powder”) to exist on the surface of the developing roller and the surface of the toner-supplying roller. At a moment when the frictional force is abruptly increased at the contact portion between the developing roller and the toner-supplying roller in the counter configuration and the configuration in which the R is larger than 1 as in the present disclosure, a strong stress is applied to the scraped powder that exists so as to be interposed at the contact portion. The scraped powder formed of the polycarbonate resin including the structural unit represented by the formula (A1) has a structure in which biphenyl moieties in the formula (A1) are stacked. Thus, at a moment when a strong stress is applied, the cleavage of the stack occurs to release the stress, and hence the abrupt increase in frictional force can be suppressed. In addition, the cleavage is more likely to occur when the developing roller and the toner-supplying roller have a counter configuration, and the R is a value larger than 1 as in the present disclosure because the stress applied to the scraped powder is strong.

In general, the angle formed by the planes of the respective two benzene rings (hereinafter referred to as “twist angle”) of unsubstituted biphenyl is 0°. However, when the benzene ring has a substituent, the twist angle may not be 0°.

However, the biphenyl structure in the structural unit represented by the formula (A1) has oxygen, which large electronegativity, at its para-position, and hence the conjugation of the π-electrons of the biphenyl becomes strong. Thus, it is presumed that the twist angle has a value close to 0° (reference: Kazuya Saito, Thermodynamic Studies of Molecular Motions in p-Polyphenyl Crystals, Netsu Sokutei 13 (4), 1986, PP. 200-207). In addition, the biphenyl structure in the structural unit represented by the formula (A1) has no substituent at its ortho-position, and hence no increase in twist angle caused by steric hindrance occurs. This fact is also presumably the reason why the twist angle has a value close to 0° (reference: Nobuyuki Sensui, Masatoshi Hasegawa, Yoichi Shindo, Rikio Yokota, Structure and Physical Properties of Novel Asymmetric Biphenyl Type Polyimide, Recent Progress in Polyimide, 1997).

As described in the above-mentioned mechanism, the effects of the present disclosure can be obtained when the above-mentioned configuration of the developing roller and the toner-supplying roller and the above-mentioned photosensitive member surface material exhibit synergistic effects on each other in the process cartridge according to the present disclosure.

The configuration of the photosensitive member used in the present disclosure is described in detail below.

### [Electrophotographic Photosensitive Member]

The photosensitive member to be used in the present disclosure includes the surface layer containing the polycarbonate resin including the structural unit represented by the formula (A1).

A method of producing the photosensitive member used in the present disclosure is, for example, a method involving: preparing coating liquids for the respective layers to be described later; applying the liquids in a desired order of the layers; and drying the liquids. In this case, examples of the method of applying the coating liquid include dip coating, spray coating, inkjet coating, roll coating, die coating, blade coating, curtain coating, wire bar coating, and ring coating. Of those, dip coating is preferred from the viewpoints of efficiency and productivity.

A support and the respective layers are described below.

### <Support>

In the present disclosure, the photosensitive member includes the support. In the present disclosure, the support is preferably an electroconductive support having electroconductivity. In addition, examples of the shape of the support include a cylindrical shape, a belt shape, and a sheet shape. A support having a cylindrical shape out of those shapes is preferred. In addition, the surface of the support may be subjected to, for example, electrochemical treatment such as anodization, blast treatment, or cutting treatment.

A metal, a resin, glass, or the like is preferred as a material for the support.

Examples of the metal include aluminum, iron, nickel, copper, gold, stainless steel, and alloys thereof. An aluminum support using aluminum out of those metals is preferred.

In addition, electroconductivity may be imparted to the resin or the glass through treatment involving, for example, mixing or coating the resin or the glass with an electroconductive material.

### <Electroconductive Layer>

The photosensitive member used in the present disclosure may be arranged with an electroconductive layer on the support. The arrangement of the electroconductive layer can conceal a flaw and unevenness on the surface of the support, and can control the reflection of light on the surface of the support.

The electroconductive layer preferably contains electroconductive particles and a resin.

A material for the electroconductive particles is, for example, a metal oxide, a metal, or carbon black.

Examples of the metal oxide include zinc oxide, aluminum oxide, indium oxide, silicon oxide, zirconium oxide, tin oxide, titanium oxide, magnesium oxide, antimony oxide, and bismuth oxide. Examples of the metal include aluminum, nickel, iron, nichrome, copper, zinc, and silver.

Of those, the metal oxide is preferably used as the electroconductive particles. In particular, titanium oxide, tin oxide, or zinc oxide is more preferably used.

When the metal oxide is used as the electroconductive particles, the surface of the metal oxide may be treated with a silane coupling agent or the like, or the metal oxide may be doped with an element, such as phosphorus or aluminum, or an oxide thereof.

Examples of the element and the oxide thereof for the doping include phosphorus, aluminum, niobium, and tantalum.

In addition, the electroconductive particles may each have a laminated configuration including a core particle and a covering layer covering the core particle. A material for the core particle is, for example, titanium oxide, barium sulfate, or zinc oxide, or zinc oxide. A material for the covering layer is, for example, a metal oxide such as tin oxide or titanium oxide.

In addition, when the metal oxide is used as the electroconductive particles, the volume-average particle diameter of the particles is preferably 1 to 500 nm, more preferably 3 to 400 nm.

Examples of the resin include a polyester resin, a polycarbonate resin, a polyvinyl acetal resin, an acrylic resin, a silicone resin, an epoxy resin, a melamine resin, a polyurethane resin, a phenol resin, and an alkyd resin.

In addition, the electroconductive layer may further contain, for example, a concealing agent, such as a silicone oil, resin particles, or titanium oxide.

The thickness of the electroconductive layer is preferably 1 to 50 μm, particularly preferably 3 to 40 μm.

The electroconductive layer may be formed by: preparing a coating liquid for an electroconductive layer containing the above-mentioned respective materials and a solvent; forming a coating film of the coating liquid; and drying the coating film. Examples of the solvent to be used in the coating liquid include an alcohol-based solvent, a sulfoxide-based solvent, a ketone-based solvent, an ether-based solvent, an ester-based solvent, and an aromatic hydrocarbon-based solvent. A dispersion method for the dispersion of the electroconductive particles in the coating liquid for an electroconductive layer is, for example, a method including using a paint shaker, a sand mill, a ball mill, or a liquid collision-type high-speed dispersing machine.

### <Undercoat Layer>

In the photosensitive member used in the present disclosure, an undercoat layer may be arranged on the support or the electroconductive layer. The arrangement of the undercoat layer can improve an adhesive function between layers to impart a charge injection-inhibiting function.

The undercoat layer preferably contains a resin. In addition, the undercoat layer may be formed as a cured film by polymerizing a composition containing a monomer having a polymerizable functional group.

Examples of the resin include a polyester resin, a polycarbonate resin, a polyvinyl acetal resin, an acrylic resin, an epoxy resin, a melamine resin, a polyurethane resin, a phenol resin, a polyvinyl phenol resin, an alkyd resin, a polyvinyl alcohol resin, a polyethylene oxide resin, a polypropylene oxide resin, a polyamide resin, a polyamic acid resin, a polyimide resin, a polyamide imide resin, and a cellulose resin.

Examples of the polymerizable functional group of the monomer having the polymerizable functional group include an isocyanate group, a blocked isocyanate group, a methylol group, an alkylated methylol group, an epoxy group, a metal alkoxide group, a hydroxyl group, an amino group, a carboxyl group, a thiol group, a carboxylic acid anhydride group, and a carbon-carbon double bond group.

In addition, the undercoat layer may further contain an electron transporting substance, a metal oxide, a metal, an electroconductive polymer, and the like for the purpose of improving electric characteristics. Of those, an electron transporting substance and a metal oxide are preferably used.

Examples of the electron transporting substance include a quinone compound, an imide compound, a benzimidazole compound, a cyclopentadienylidene compound, a fluorenone compound, a xanthone compound, a benzophenone compound, a cyanovinyl compound, a halogenated aryl compound, a silole compound, and a boron-containing compound. An electron transporting substance having a polymerizable functional group may be used as the electron-transporting material and copolymerized with the above-mentioned monomer having a polymerizable functional group to form the undercoat layer as a cured film.

Examples of the metal oxide include indium tin oxide, tin oxide, indium oxide, titanium oxide, zinc oxide, aluminum oxide, and silicon dioxide. Examples of the metal include gold, silver, and aluminum.

In addition, the undercoat layer may further contain an additive.

The thickness of the undercoat layer is preferably 0.1 to 50 μm, more preferably 0.2 to 40 μm, particularly preferably 0.3 to 30 μm.

The undercoat layer may be formed by: preparing a coating liquid for an undercoat layer containing the above-mentioned respective materials and a solvent; forming a coating film of the coating liquid; and drying and/or curing the coating film. Examples of the solvent to be used in the coating liquid include an alcohol-based solvent, a ketone-based solvent, an ether-based solvent, an ester-based solvent, and an aromatic hydrocarbon-based solvent.

### <Photosensitive Layer>

The photosensitive layer of the photosensitive member used in the present disclosure is mainly classified into (1) a laminate type photosensitive layer and (2) a monolayer type photosensitive layer. (1) The laminate type photosensitive layer includes a charge generating layer containing a charge generating substance and a charge transporting layer containing a charge transporting substance. (2) The monolayer type photosensitive layer includes a photosensitive layer containing both of the charge generating substance and the charge transporting substance.

(1) Laminate Type Photosensitive Layer The laminate type photosensitive layer includes the charge generating layer and the charge transporting layer.

### (1-1) Charge Generating Layer

The charge generating layer preferably contains the charge generating substance and a resin.

Examples of the charge generating substance include an azo pigment, a perylene pigment, a polycyclic quinone pigment, an indigo pigment, and a phthalocyanine pigment. Of those, an azo pigment and a phthalocyanine pigment are preferred. Of the phthalocyanine pigments, an oxytitanium phthalocyanine pigment, a chlorogallium phthalocyanine pigment, and a hydroxygallium phthalocyanine pigment are preferred.

The content of the charge generating substance in the charge generating layer is preferably 40 to 85 mass %, more preferably 60 to 80 mass % with respect to the total mass of the charge generating layer.

Examples of the resin include a polyester resin, a polycarbonate resin, a polyvinyl acetal resin, a polyvinyl butyral resin, an acrylic resin, a silicone resin, an epoxy resin, a melamine resin, a polyurethane resin, a phenol resin, a polyvinyl alcohol resin, a cellulose resin, a polystyrene resin, a polyvinyl acetate resin, and a polyvinyl chloride resin. Of those, a polyvinyl butyral resin is more preferred.

In addition, the charge generating layer may further contain an additive, such as an antioxidant or a UV absorber. Specific examples thereof include a hindered phenol compound, a hindered amine compound, a sulfur compound, a phosphorus compound, and a benzophenone compound.

The thickness of the charge generating layer is preferably 0.1 to 1 μm, more preferably 0.15 to 0.4 μm.

The charge generating layer may be formed by: preparing a coating liquid for a charge generating layer containing the above-mentioned respective materials and a solvent; forming a coating film of the coating liquid; and drying the coating film. Examples of the solvent to be used in the coating liquid include an alcohol-based solvent, a sulfoxide-based solvent, a ketone-based solvent, an ether-based solvent, an ester-based solvent, and an aromatic hydrocarbon-based solvent.

### (1-2) Charge Transporting Layer

The charge transporting layer preferably contains the charge transporting substance and a resin.

Examples of the charge transporting substance include a polycyclic aromatic compound, a heterocyclic compound, a hydrazone compound, a styryl compound, an enamine compound, a benzidine compound, a triarylamine compound, and a resin having a group derived from each of these substances. Of those, a triarylamine compound and a benzidine compound are preferred.

The structures of CTM1 to CTM10 are shown below as preferred examples of the charge transporting substance.

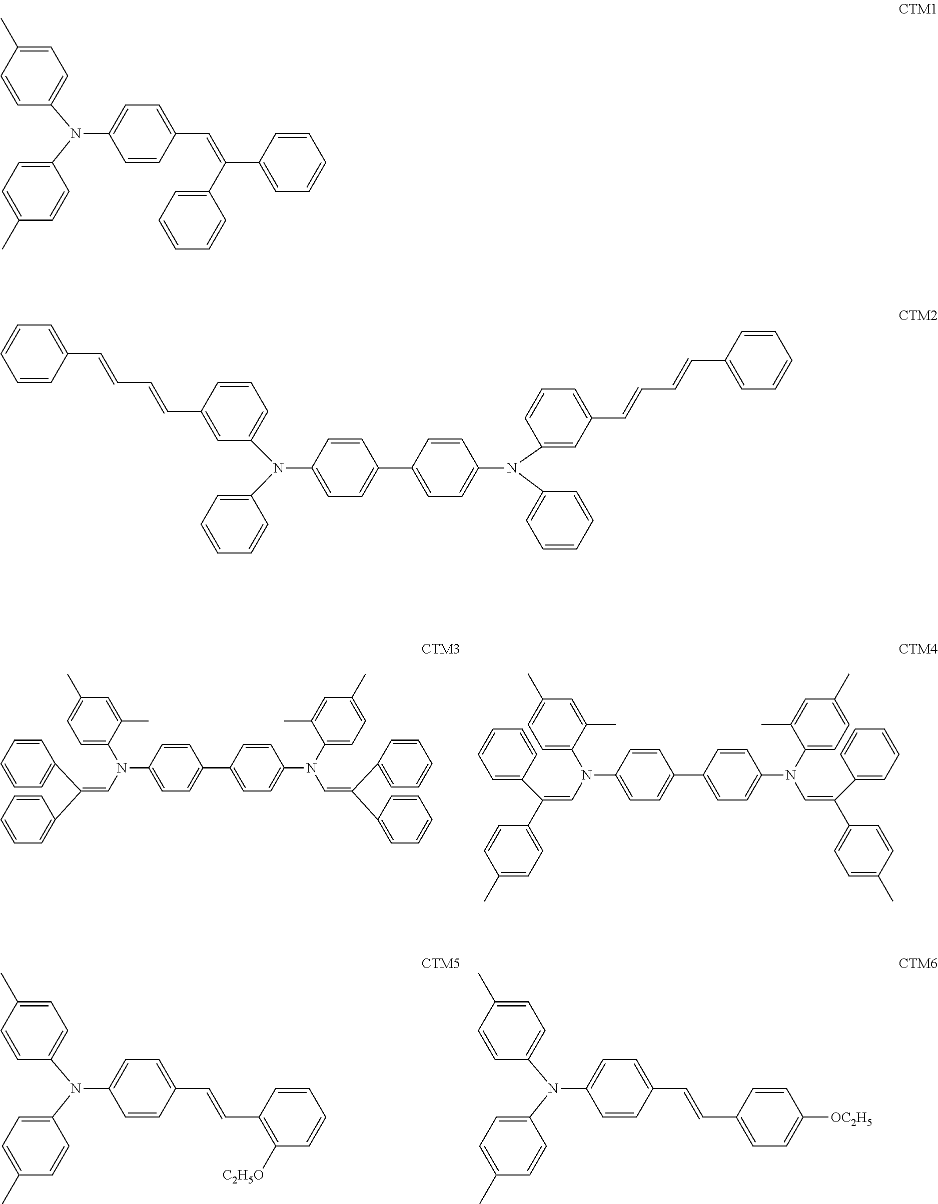

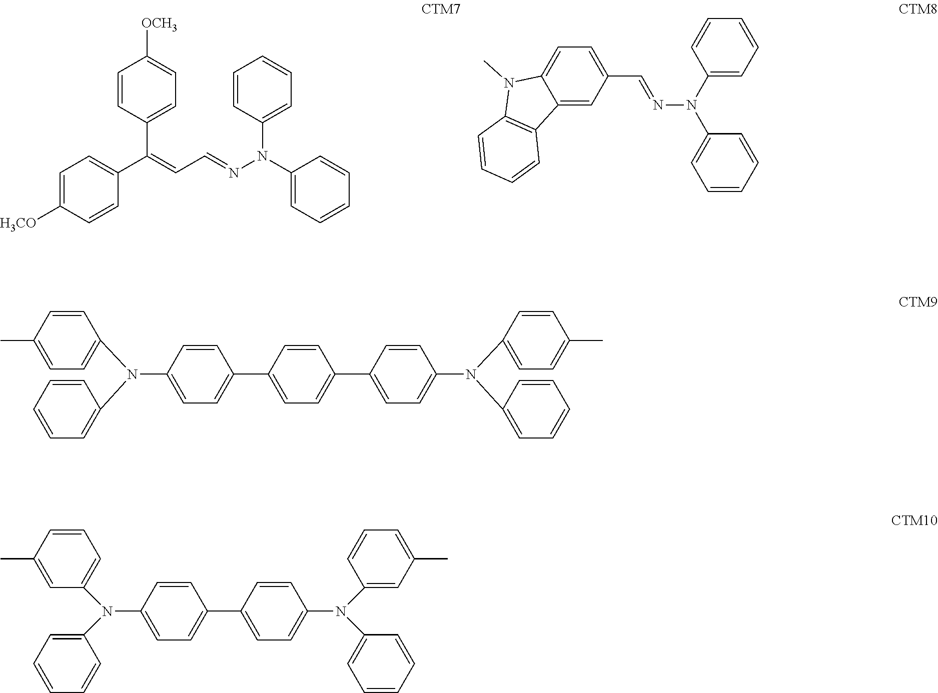

The content of the charge transporting substance in the charge transporting layer is preferably from 25 to 70 mass %, more preferably from 30 to 55 mass % with respect to the total mass of the charge transporting layer.

Examples of the resin include a polyester resin, a polycarbonate resin, an acrylic resin, and a polystyrene resin. Of those, a polycarbonate resin, a polyester resin, and an acrylic resin are preferred. A polyarylate resin is particularly preferred as the polyester resin.

A content ratio (mass ratio) between the charge transporting substance and the resin is preferably from 4:10 to 20:10, more preferably from 5:10 to 12:10.

In addition, the charge transporting layer may contain an additive, such as an antioxidant, a UV absorber, a plasticizer, a leveling agent, a slipperiness-imparting agent, or a wear resistance-improving agent. Specific examples thereof include a hindered phenol compound, a hindered amine compound, a sulfur compound, a phosphorus compound, a benzophenone compound, a siloxane-modified resin, a silicone oil, fluorine resin particles, polystyrene resin particles, polyethylene resin particles, silica particles, alumina particles, and boron nitride particles.

The thickness of the charge transporting layer is preferably 5 to 50 μm, more preferably 8 to 40 μm, particularly preferably 10 to 30 μm.

The charge transporting layer may be formed by: preparing a coating liquid for a charge transporting layer containing the above-mentioned respective materials and a solvent; forming a coating film of the coating liquid; and drying the coating film. Examples of the solvent to be used in the coating liquid include an alcohol-based solvent, a ketone-based solvent, an ether-based solvent, an ester-based solvent, and an aromatic hydrocarbon-based solvent. Of those solvents, an ether-based solvent or an aromatic hydrocarbon-based solvent is preferred.

### (2) Monolayer Type Photosensitive Layer

The monolayer type photosensitive layer may be formed by: preparing a coating liquid for a photosensitive layer containing the charge generating substance, the charge transporting substance, a resin, and a solvent; forming a coating film of the coating liquid; and drying the coating film. The charge generating substance, the charge transporting substance, and the resin are the same as the examples of the materials in the above-mentioned section “(1) Laminate Type Photosensitive Layer.”

### <Protection Layer>

In the photosensitive member used in the present disclosure, a protection layer may be arranged on the photosensitive layer. The arrangement of the protection layer can improve durability.

It is only required that the protection layer be, for example, a resin-containing layer having high strength from the viewpoint that the layer is arranged for the purpose of imparting durability in response to long life. It is not necessarily required to enhance the charge transporting performance of the layer by incorporating electroconductive particles or a charge transporting substance into the layer. However, from the viewpoint of enhancing the basic electrical characteristics of the photosensitive member, it is preferred to achieve both the durability and the basic electrical characteristics by incorporating the electroconductive particle and/or the charge transporting substance, and a resin.

Examples of the electroconductive particles include particles of metal oxides, such as titanium oxide, zinc oxide, tin oxide, and indium oxide.

Examples of the charge transporting substance include a polycyclic aromatic compound, a heterocyclic compound, a hydrazone compound, a styryl compound, an enamine compound, a benzidine compound, a triarylamine compound, and a resin having a group derived from each of these substances. Of those, a triarylamine compound and a benzidine compound are preferred.

Examples of the resin include a polyester resin, an acrylic resin, a phenoxy resin, a polycarbonate resin, a polystyrene resin, a phenol resin, a melamine resin, and an epoxy resin. Of those, a polycarbonate resin, a polyester resin, and an acrylic resin are preferred.

In addition, the protection layer may be formed as a cured film by polymerizing a composition containing a monomer having a polymerizable functional group. As a reaction in this case, there are given, for example, a thermal polymerization reaction, a photopolymerization reaction, and a radiation polymerization reaction. Examples of the polymerizable functional group of the monomer having a polymerizable functional group include an acryloyl group and a methacryloyl group. A material having a charge transporting ability may be used as the monomer having a polymerizable functional group.

The protection layer may contain an additive, such as an antioxidant, a UV absorber, a plasticizer, a leveling agent, a slipperiness-imparting agent, or a wear resistance-improving agent. Specific examples thereof include a hindered phenol compound, a hindered amine compound, a sulfur compound, a phosphorus compound, a benzophenone compound, a siloxane-modified resin, a silicone oil, fluorine resin particles, polystyrene resin particles, polyethylene resin particles, silica particles, alumina particles, and boron nitride particles.

The protection layer has a thickness of preferably from 0.5 to 10 μm, more preferably from 1 to 7 μm.

The protection layer may be formed by preparing a coating liquid for a protection layer containing the above-mentioned materials and a solvent, forming a coat thereof, and drying and/or curing the coat. Examples of the solvent to be used for the coating liquid include an alcohol-based solvent, a ketone-based solvent, an ether-based solvent, a sulfoxide-based solvent, an ester-based solvent, and an aromatic hydrocarbon-based solvent.

### <Surface Layer>

In the photosensitive member to be used in the present disclosure, the surface layer contains a polycarbonate resin including a structural unit represented by the following formula (A1):

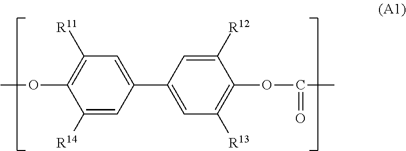

in the formula (A1), R¹¹ to R¹⁴ each independently represent a hydrogen atom or a methyl group.

The surface layer as used herein is a portion in which the photosensitive member is brought into contact with toner and various members during an electrophotographic process. The protection layer, the charge transporting layer, and the monolayer type photosensitive layer may each be the surface layer, but the surface layer is preferably the charge transporting layer from the viewpoint of achieving both the cost and the basic electrical characteristics in the electrophotographic process.

It is preferred that the polycarbonate resin including the structural unit represented by the formula (A1) include at least one kind of structural unit selected from the group consisting of: a structural unit represented by the following formula (A2); and a structural unit represented by the following formula (A3).

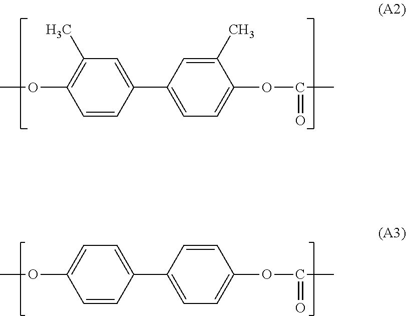

It is suitable for exhibiting the effects of the present disclosure that the number of methyl groups at the meta-position of the biphenyl structure be 2 or 0 as represented by each of the formula (A2) and the formula (A3) because the increase in twist angle caused by steric hindrance is suppressed.

In addition, it is preferred that the polycarbonate resin including the structural unit represented by the formula (A1) further include a structural unit represented by the following formula (A4).

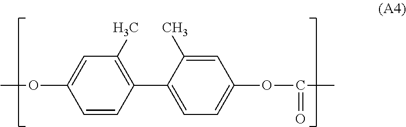

When there are two methyl groups at the ortho-position of the biphenyl structure as represented by the formula (A4), the twist angle caused by steric hindrance is increased. When the above-mentioned polycarbonate resin partially includes such structural unit in which the twist angle in the biphenyl structure is increased, the stack of the biphenyl structures is partially disturbed, and the crystallinity of the scraped powder is moderately weakened. Thus, the aggregation of particles of the scraped powder can be suppressed. As a result, the particles of the scraped powder can be uniformly dispersed in the toner interposed between the developing roller and the toner-supplying roller while the suppressing effect on the abrupt increase in frictional force by the cleavage of the stack of the biphenyl structures is maintained.

When the polycarbonate resin including the structural unit represented by the formula (A1) further includes the structural unit represented by the formula (A4), the dispersibility of the particles of the scraped powder in the toner is improved even at the time of, in particular, use under an environment in which the particles of the toner are liable to be aggregated, such as a high-temperature and high-humidity environment. Thus, the effects of the present disclosure are easily obtained even at the time of the use under the high-temperature and high-humidity environment.

The ratio of the content of the structural unit represented by the formula (A4) in the surface layer preferably satisfies the following from the viewpoint of further optimizing the balance between the stack of the biphenyl structures in the scraped powder and the dispersibility of the particles of the scraped powder in the toner as described above. That is, the ratio of the content of the structural unit represented by the formula (A4) with respect to the total of the content of the structural unit represented by the formula (A1) and the content of the structural unit represented by the formula (A4) in the surface layer is preferably 30 to 70 mol %.

In addition, the content ratio of the polycarbonate resin including the structural unit represented by the formula (A1) in the surface layer preferably satisfies the following from the viewpoint of optimizing the balance between the generation amount of the scraped powder in the latter half of endurance and the durability of the surface layer at the time of repeated use. That is, the content ratio of the polycarbonate resin including the structural unit represented by the formula (A1) with respect to the total mass of the surface layer in the surface layer is preferably 5 to 20 mass %.

<Identification Method for Structural Unit represented by Formula (A2) and Structural Unit represented by Formula (A4)>

The fact that the surface layer of the photosensitive member to be used in the present disclosure contains the structural unit represented by the formula (A2) and the structural unit represented by the formula (A4) may be identified as described below. A total ion chromatogram (TIC) is obtained by subjecting a polymer component recovered from the surface layer of the photosensitive member to pyrolysis-gas chromatography-mass spectrometry under coexistence with tetramethylammonium hydroxide (TMAH). When the TIC has a mass spectrum including components corresponding to m/z=242 and m/z=227, it can be determined that the above-mentioned surface layer contains the polycarbonate resin including the structural unit represented by the formula (A2) and the structural unit represented by the formula (A4). Further, a ¹H-nuclear magnetic resonance spectrum (NMR spectrum) is obtained by subjecting the above-mentioned polymer component to ¹H-nuclear magnetic resonance analysis in deuterated chloroform. When the ¹H-nuclear magnetic resonance spectrum (NMR spectrum) has a peak at 2.35±0.02 ppm, it can be determined that the above-mentioned surface layer contains the polycarbonate resin including the structural unit represented by the formula (A2). In addition, when the above-mentioned NMR spectrum has a peak at 2.40±0.02 ppm, it can be determined that the above-mentioned surface layer contains the polycarbonate resin including the structural unit represented by the formula (A4).

Specific examples of methods for the recovery of the polymer component from the surface layer, and the pyrolysis-gas chromatography-mass spectrometry (pyrolysis GCMS) and the ¹H-nuclear magnetic resonance analysis each using the recovered polymer component are described below.

<Recovery of Polymer Component from Surface Layer>

The recovery of the polymer component from the surface layer is performed by the following procedure through the reprecipitation of a resin in the surface layer.

### 1. Cutting of Electrophotographic Photosensitive Member

The photosensitive member is cut at a position distant from the end portion of the photosensitive member by 10 cm in its generating line direction with a scroll saw.

2. Washing of Inner Surface of 10 cm Photosensitive Member Having been Cut Out

The inner surface of the photosensitive member is wiped with lens-cleaning paper impregnated with chloroform.

### 3. Elution of Surface Layer

A portion corresponding to 3 cm from the end portion of the photosensitive member on the cut surface side is immersed in chloroform.

Specifically, about 60 cc of chloroform is loaded into a 100 mL beaker, and the immersion is performed at normal temperature for 5 minutes.

### 4. Concentration (Preparation of Concentrated Solution)

The resultant is concentrated to 2 mL with a rotary evaporator.

### 5. Reprecipitation

50 mL of a methanol/acetone mixed liquid (volume ratio: 1:1) is prepared, and the whole amount of the concentrated solution is dropped thereinto under stirring.

### 6. Filtration

A paper filter (No. 5C-40, manufactured by Kiriyama Glass Co.) was set on a Kiriyama funnel (SU-40, manufactured by Kiriyama Glass Co.), and suction filtration is performed.

### 7. Drying

The residue on the paper filter is recovered with a spatula, and is subjected to vacuum drying (70° C., 1 hour).

### <Pyrolysis-GCMS Measurement>

Specific identification conditions for the structural units of the polycarbonate resin by the pyrolysis GCMS are described below.

Apparatus configuration: Pyrolyzer+gas chromatography (GC) apparatus+mass spectrometry (MS) apparatus
Pyrolyzer: JPS-700 manufactured by Japan Analytical Industry Co., Ltd.
GC apparatus: FOCUS GC manufactured by Thermo Fisher Scientific K.K.
MS apparatus: ISQ manufactured by Thermo Fisher Scientific K.K.
Sample amount: 0.1 mg (containing TMAH (manufactured by Tama Chemicals Co., Ltd.))
Pyrolysis temperature: 590° C. (using Pyrofoil F590 manufactured by Japan Analytical Industry Co., Ltd.)
Column: “HP5-MS” (19091S-433 manufactured by Agilent Technologies Japan, Ltd., length: 30 m, inner diameter: 0.25 mm, film thickness: 0.25 μm)
GC inlet conditions: Inlet Temp: 250° C., Split Flow: 50 mL/min
GC temperature increase conditions: 40° C. (5 min)→10° C./min (300° C.)→300° C. (20 min)
MS conditions: Ion Source Temp: 200° C.
MS Transfer Line Temp: 250° C.

### <¹H-Nuclear Magnetic Resonance Analysis>

Specific identification conditions for the structural units of the polycarbonate resin by the ¹H-nuclear magnetic resonance analysis are described below.

### Measurement Sample Preparation

20 mg of a sample is dissolved into 1 g of deuterated chloroform containing tetramethylsilane serving as a reference substance, and the whole amount thereof is transferred to a tube for ¹H-nuclear magnetic resonance analysis. For example, deuterated chloroform (manufactured by Sigma-Aldrich Japan G.K., chloroform-d, model number: 612200) may be used as the deuterated chloroform. In addition, an NMR tube (manufactured by Norell, Inc., ST500-7, model number: S3010) may be used as the tube for ¹H-nuclear magnetic resonance analysis.
NMR Spectrum Measurement
Apparatus: AVANCE 500 manufactured by Bruker
Conditions: Proton NMR, automatic measurement by Icon-NMR
Number of scans: 32
Reference peak: The peak of the methyl groups of tetramethylsilane is set as 0 ppm.

Next, the configuration of the developing roller to be used in the present disclosure is described in detail below.

### [Developing Roller]

Any developing roller typically used for developing an electrostatic latent image formed on the surface of a photosensitive member in an electrophotographic process may be used as the developing roller to be used in the present disclosure without any particular limitation. A developing roller including an electroconductive substrate and an elastic layer may be used as the developing roller. The developing roller may be specifically, for example, an elastic body roller having a configuration in which an electroconductive elastic rubber layer having a predetermined volume resistivity is arranged as the elastic layer on the periphery of a metal core made of a metal.

### <Electroconductive Substrate>

A columnar or hollow cylindrical electroconductive mandrel may be used as the electroconductive substrate. The electroconductive mandrel may include the following electroconductive material. That is, examples of the electroconductive material include: a metal or an alloy, such as aluminum, a copper alloy, or stainless steel; iron subjected to plating treatment with chromium or nickel; and a synthetic resin having electroconductivity. A known adhesive may be appropriately applied to the surface of the electroconductive substrate for the purpose of improving its adhesive property with, for example, the elastic layer arranged on the outer periphery of the electroconductive substrate.

### <Elastic Layer>

The elastic layer is typically preferably formed of a molded body of a rubber material. Examples of the rubber material include an ethylene-propylene-diene copolymerized rubber (EPDM), an acrylonitrile-butadiene rubber (NBR), a chloroprene rubber (CR), a natural rubber (NR), an isoprene rubber (IR), a styrene-butadiene rubber (SBR), a fluororubber, a silicone rubber, an epichlorohydrin rubber, a hydrogenated product of NBR, and a urethane rubber. Those rubber materials may be used alone or in combination thereof.

The elastic layer may be one layer or may be formed of a plurality of layers. When the elastic layer is formed of a plurality of layers, the plurality of layers may include a plurality of layers formed of, out of the rubber materials described above, the materials identical to each other, or may include a plurality of layers formed of the materials different from each other.

From the viewpoint of suppressing a change in dynamic friction coefficient between the developing roller and the photosensitive member, an MD-1 hardness measured at a temperature of 23° C. for the outer surface of the developing roller may be, for example, 20° to 55°.

Electroconductivity may be imparted to the elastic layer by blending an electroconductivity-imparting agent, such as an electronic electroconductive substance or an ionic electroconductive substance.

Examples of the electronic electroconductive substance include: electroconductive carbons including carbon blacks, such as ketjen black EC and acetylene black; carbons for rubbers, such as super abrasion furnace (SAF), intermediate SAF (ISAF), high abrasion furnace (HAF), fast extruding furnace (FEF), general purpose furnace (GPF), semi-reinforcing furnace (SRF), fine thermal (FT), and medium thermal (MT); carbons for colors (inks) each subjected to oxidation treatment; and metals, such as copper, silver, and germanium, and metal oxides thereof. Of those, electroconductive carbon is preferred because the electroconductivity can be easily controlled with a small amount.

Examples of the ionic electroconductive substance include: inorganic ionic electroconductive substances, such as sodium perchlorate, lithium perchlorate, calcium perchlorate, and lithium chloride; and organic ionic electroconductive substances, such as a modified aliphatic dimethylammonium ethosulfate and stearylammonium acetate.

Those electroconductivity-imparting agents are each appropriately blended in a required amount in accordance with the electroconductivity required in the elastic layer.

Various additives, such as particles, an electroconductive agent, a plasticizer, a filler, an extender, a crosslinking agent, a crosslinking accelerator, a vulcanization aid, a crosslinking aid, an acid acceptor, a curing inhibitor, an antioxidant, and an age inhibitor, may each be further incorporated into the elastic layer as required. Those optional components may each be blended in an amount in such a range that the features of the present disclosure are not impaired.

Examples of the crosslinking agent include sulfur-based crosslinking agents including sulfurs, such as powdered sulfur, oil-treated powdered sulfur, precipitated sulfur, colloidal sulfur, and dispersible sulfur, and organic sulfur-containing compounds, such as tetramethylthiuram disulfide and N,N-dithiobismorpholine. The blending ratio of the sulfur is preferably 0.5 to 2.0 parts by mass or less per 100 parts by mass of the total amount of the rubber material in consideration of impartment of satisfactory characteristics as the rubber. In addition, when the organic sulfur-containing compound is used as the crosslinking agent, the amount of sulfur in the molecule is preferably adjusted to the ratio within the above-mentioned range.

Examples of the crosslinking accelerator for accelerating the crosslinking include a thiuram-based accelerator, a thiazole-based accelerator, a thiourea-based accelerator, a guanidine-based accelerator, a sulfenamide-based accelerator, and a dithiocarbamate-based accelerator. The crosslinking accelerator is blended in an appropriate amount in accordance with molding conditions and a vulcanization speed required for the shape of a molded product.

Examples of the crosslinking aid include hitherto known crosslinking aids including: metal compounds, such as zinc oxide; and fatty acids, such as stearic acid and oleic acid. When the crosslinking aid is used, the content ratio of the crosslinking aid is preferably 0.1 part by mass or more with respect to 100 parts by mass of the total amount of the rubber material, and is preferably 7.0 parts by mass or less with respect thereto.

The acid acceptor is used for preventing a chlorine-based gas generated from, for example, an epichlorohydrin rubber and a CR at the time of the crosslinking from remaining inside the electrophotographic members of a finished product and preventing, for example, crosslinking inhibition and contamination of other members caused by the remaining gas from occurring. Various substances each acting as an acid receptor may be used as the acid acceptor, and a hydrotalcite, which is excellent in dispersibility, is preferably used.

For example, zinc oxide, silica, carbon black, talc, calcium carbonate, magnesium carbonate, and aluminum hydroxide may each be used as the filler. The mechanical strength of a binder resin can be expected to be improved by blending any such filler. In addition, as described above, electronic electroconductivity may be imparted to an electrophotographic member by using electroconductive carbon black that functions as an electronic electroconductive agent as the filler. The filler is appropriately blended in a required amount in accordance with characteristics required for a molded body.

Next, the configuration of the toner-supplying roller to be used in the present disclosure is described in detail below.

### [Toner-Supplying Roller]

In the present disclosure, a toner-supplying roller including an electroconductive shaft body and a resin layer on the shaft body may be used as the toner-supplying roller.

### <Shaft Body>

The shaft body functions as a support member for the toner-supplying roller and an electrode. The shaft body includes an electroconductive material, for example, a metal or an alloy, such as aluminum, a copper alloy, or stainless steel; iron subjected to plating treatment with chromium or nickel; or a synthetic resin having electroconductivity. The shaft body has a solid columnar shape or a hollow cylindrical shape.

### <Resin Layer>

The resin layer preferably contains a crosslinked urethane resin to be described later from the viewpoint of strength.

In addition, to uniformly supply toner particles to the surface of the developing roller as the toner-supplying roller, the resin layer is preferably a foamed layer having a void that can store the toner particles in the layer. Examples of the void include a large number of through holes and non-through holes. In addition, another example of the void may be a porous form in a state in which bubbles are connected to each other (open cell). The foamed layer containing the crosslinked urethane resin is preferably in an open cell state having a large void. The physical property values of such foamed layer having a void, such as the average cell diameter on the surface thereof, the number of cells thereof, the airflow rate thereof, and the density of the entirety of the layer, are important for the function of the foamed layer. The physical property values of the foamed layer are not particularly limited, and, for example, the foamed layer preferably has values that fall within the following numerical ranges.
Average cell diameter on surface: 100 to 500 μm
Number of cells: 50 to 300 cells/inch
Airflow rate: 0.5 to 3.0 L/min
Density: 0.05 to 0.20 g/cm3

### <Crosslinked Urethane Resin>

The crosslinked urethane resin is a reaction product between a polyol and a compound having an isocyanate group. Examples of the polyol to be used for synthesizing the crosslinked urethane resin include a polyester polyol, a polyether polyol, an acrylic polyol, a polycarbonate polyol, and a polycaprolactone polyol. Of those, a polyether polyol is preferred from the viewpoint of improving the flexibility of the crosslinked urethane resin.

Examples of the polyether polyol include polyethylene glycol, polypropylene glycol, poly-1,4-butanediol, poly-1,5-pentanediol, polyneopentyl glycol, poly-3-methyl-1,5-pentanediol, poly-1,6-hexanediol, poly-1,8-octanediol, and poly-1,9-nonanediol. Of those, polypropylene glycol, pol-y1,4-butanediol, poly-1,5-pentanediol, polyneopentyl glycol, poly-3-methyl-1,5-pentanediol, and poly-1,6-hexanediol are preferred from the viewpoint of suppressing an increase in hardness.

In addition, examples of the polyester polyol include polyester polyols obtained by a condensation reaction between diol components, such as ethylene glycol, propylene glycol, 1,4-butanediol, 1,5-pentanediol, neopentyl glycol, 3-methyl-1,5-pentanediol, 1,6-hexanediol, 1,8-octanediol, and 1,9-nonanediol, or triol components such as trimethylolpropane and dicarboxylic acids, such as adipic acid, suberic acid, sebacic acid, phthalic anhydride, terephthalic acid, and hexahydroxyphthalic acid. Of those, polyester polyols obtained by a condensation reaction between diol components, such as propylene glycol, 1,4-butanediol, 1,5-pentanediol, neopentyl glycol, 3-methyl-1,5-pentanediol, and 1,6-hexanediol, and dicarboxylic acids, such as adipic acid, suberic acid, and sebacic acid, are preferred from the viewpoint of suppressing an increase in hardness of the resin layer.

In addition, examples of the polycaprolactone polyol include poly-ε-caprolactone and poly-γ-caprolactone.

In addition, examples of the polycarbonate polyol include polycarbonate polyols obtained by a condensation reaction between diol components, such as ethylene glycol, propylene glycol, 1,4-butanediol, 1,5-pentanediol, neopentyl glycol, 3-methyl-1,5-pentanediol, 1,6-hexanediol, 1,8-octanediol, and 1,9-nonanediol, and dialkyl carbonates, such as phosgene and dimethyl carbonate, or cyclic carbonates such as ethylene carbonate. Of those, polycarbonate polyols obtained by a condensation reaction between diol components, such as neopentyl glycol, 3-methyl-1,5-pentanediol, 1,5-pentanediol, 1,6-hexanediol, and 1,8-octanediol, and dialkyl carbonates such as dimethyl carbonate are preferred from the viewpoint of suppressing an increase in hardness of the resin layer. Those polyol components may be turned into prepolymers subjected to chain extension in advance with isocyanate compounds, such as 2,4-tolylene diisocyanate (TDI), 4,4′-diphenylmethane diisocyanate (MDI), and isophorone diisocyanate (IPDI), as required.

### <Isocyanate Compound>

The isocyanate compound is not particularly limited, and the isocyanate compounds may each be used: aliphatic polyisocyanates, such as ethylene diisocyanate and 1,6-hexamethylene diisocyanate (HDI); alicyclic polyisocyanates, such as isophorone diisocyanate (IPDI), cyclohexane-1,3-diisocyanate, and cyclohexane-1,4-diisocyanate; aromatic isocyanates, such as 2,4-tolylene diisocyanate, 2,6-tolylene diisocyanate (TDI), 4,4′-diphenylmethane diisocyanate (MDI), polymeric diphenylmethane diisocyanate, xylylene diisocyanate, and naphthalene diisocyanate; and copolymers, isocyanurate forms, TMP adduct forms, biuret forms, and blocked forms thereof. Of those, aromatic isocyanates, such as tolylene diisocyanate and diphenylmethane diisocyanate, are preferred. It is preferred that the polyol component and the isocyanate compound be mixed so that the ratio (molar ratio) of an isocyanate group in the isocyanate compound falls within the range of 1.0 to 2.0 with respect to 1.0 of a hydroxy group in the polyol component. When the mixing ratio falls within the above-mentioned range, the remaining of unreacted components can be suppressed.

### <Crosslinking Agent>

A material for synthesizing the crosslinked urethane resin preferably contains a crosslinking agent. Examples of the crosslinking agent include an isocyanate that is trifunctional or more and a polyol that is trifunctional or more, and a crosslinking structure may be formed by using these crosslinking agents. In addition, separately from the foregoing, a known crosslinking agent suitable for the urethane resin may be used. Examples the known crosslinking agent suitable for the urethane resin include an amine-based crosslinking agent such as ethylenediamine and an imide-based crosslinking agent such as a carbodiimide.

### <Other Component in Resin Layer>

The resin layer may contain an electroconductive filler to the extent that the effects of the present disclosure are not impaired, as required. Carbon black and an electroconductive metal, such as aluminum or copper, may each be used as the electroconductive filler. Of those, carbon black is particularly preferably used because the carbon black is relatively easily available, and has a high electroconductivity-imparting property and a high reinforcing property. In the resin layer, a catalyst, a foaming agent, a foam stabilizer, and other aids may be used, as required.

The catalyst is not particularly limited, and a catalyst appropriately selected from various hitherto known catalysts may be used. For example, an amine-based catalyst (e.g., triethylenediamine, bis(dimethylaminoethyl) ether, N,N,N′,N′-tetramethylhexanediamine, 1,8-diazabicyclo(5.4.0) undecene-7, 1,5-diazabicyclo(4.3.0) nonene-5, 1,2-dimethylimidazole, N-ethylmorpholine, or N-methylmorpholine), an organometallic catalyst (e.g., tin octylate, tin oleate, dibutyltin dilaurate, dibutyltin diacetate, titanium tetra-i-propoxide, titanium tetra-n-butoxide, or tetrakis(2-ethylhexyloxy) titanium), or an acid salt catalyst obtained by reducing the initial activity of each of the amine-based catalyst and the organometallic catalyst (e.g., a carboxylic acid salt, a formic acid salt, an octylic acid salt, or a boric acid salt) may be used. The catalysts may be used alone or in combination thereof.

The foaming agent is not particularly limited, and a foaming agent appropriately selected from various hitherto known foaming agents may be used. In particular, water is suitably used as the foaming agent because the water reacts with a polyisocyanate to generate carbon dioxide. In addition, even when another foaming agent and water are used in combination, the main purpose of the present disclosure is not impaired.

The foam stabilizer is not particularly limited, and a foam stabilizer appropriately selected from various hitherto known foam stabilizers may be used. As required, a crosslinking aid, a flame retardant, a colorant, a UV absorber, an antioxidant, and the like may be used as other aids to the extent that the effects of the present disclosure are not impaired.

### [Process Cartridge and Electrophotographic Apparatus]

A process cartridge according to the present disclosure is a process cartridge being detachably attachable onto a main body of an electrophotographic apparatus, and is characterized by including the electrophotographic photosensitive member, the developing roller, and the toner-supplying roller described in the foregoing. In the process cartridge, the developing roller is configured to develop an electrostatic latent image formed on the surface of the photosensitive member, and the toner-supplying roller is arranged in contact with the developing roller and is configured to supply toner to the developing roller.

In addition, an electrophotographic apparatus according to the present disclosure is characterized by including the above-mentioned process cartridge.

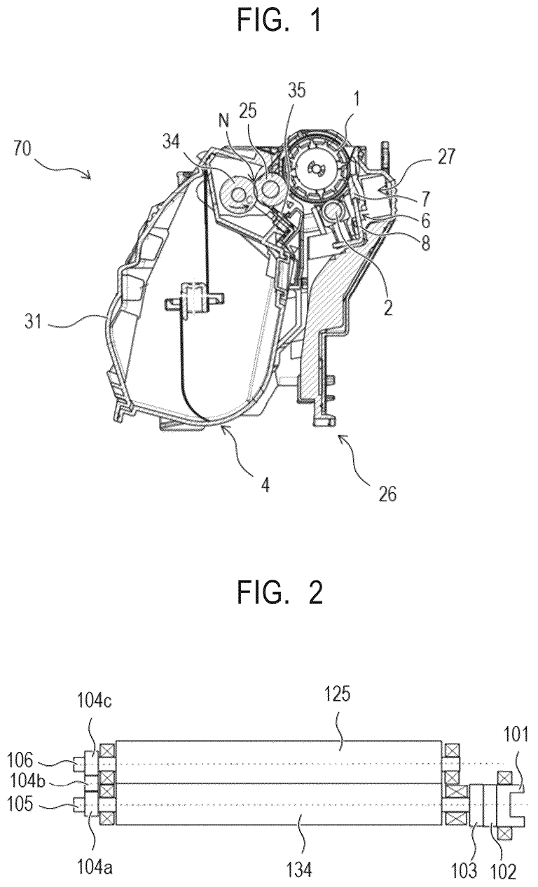

FIG. 1 is an illustration of an example of the main cross-section of a process cartridge 70 including a photosensitive member, a developing roller, and a toner-supplying roller.

The process cartridge 70 includes a photosensitive unit 26 and a developing unit 4. The photosensitive unit 26 includes a photosensitive drum 1, a charging roller 2, and a cleaning member 6. In addition, the developing unit 4 includes a developing roller 25 and a toner-supplying roller 34.

The charging roller 2 and the cleaning member 6 described above are arranged on the periphery of the photosensitive drum 1. The cleaning member 6 includes an elastic member 7 formed of a rubber blade and a cleaning support member 8. The distal end portion of the elastic member 7 is arranged in abutment against the photosensitive drum 1 in a counter direction with respect to the rotation direction thereof. In addition, the toner removed from the surface of the photosensitive drum 1 by the cleaning member 6 falls into a removal toner chamber 27.

The photosensitive drum 1 is rotationally driven in accordance with an image forming operation by transmitting the driving force of a main body drive motor (not shown), which is a drive source, to the photosensitive unit 26.

The charging roller 2 is rotatably mounted on the photosensitive unit 26 through intermediation of a charging roller bearing, is pressurized toward the photosensitive drum 1 by a charging roller-pressurizing member to be brought into abutment against the photosensitive drum 1, and is thus rotated following the rotation of the photosensitive drum 1.

The developing unit 4 includes the developing roller 25 that is rotated in contact with the photosensitive drum 1 and a developing frame 31 that supports the developing roller 25. The toner-supplying roller 34 that is rotated in the direction of the arrow C in contact with the developing roller 25 and a developing blade 35 for regulating a toner layer on the developing roller 25 are each arranged on the periphery of the developing roller 25.

The elastic layer of the developing roller may be formed of, for example, a base layer and a surface layer. In this case, a silicone rubber and a urethane rubber may be used for the base layer and the surface layer, respectively, and a desired roughness may be set by dispersing particles of urethane beads in the urethane rubber of the surface layer. The developing roller 25 and the photosensitive drum 1 are each rotated so that their surfaces move in the same direction in an opposed portion (contact portion). Toner negatively charged by frictional charging against a predetermined DC bias applied to the developing roller 25 is transferred only to a light portion potential portion based on its potential difference in a developing portion that is brought into contact with the photosensitive drum 1, to thereby visualize an electrostatic latent image.

The developing blade 35 is arranged below the developing roller 25 on the drawing sheet in which FIG. 1 is illustrated, and is in abutment against the developing roller 25 in a counter direction to regulate the coat amount of toner supplied by the toner-supplying roller 34 and apply charge to the toner. The developing blade 35 may include a plate member having flexibility and a developing blade support that fixes the plate member. In addition, the developing blade 35 may include an elastic plate formed of stainless steel (SUS) or the like. The toner is frictionally charged by sliding between the developing blade 35 and the developing roller 25 to be given charge and is simultaneously regulated for layer thickness. In addition, a predetermined voltage is applied to the developing blade 35 from a blade bias power supply (not shown) to stabilize the toner coat.

The toner-supplying roller 34 is in abutment against the developing roller 25 with a nip portion N. In the present disclosure, the toner-supplying roller 34 and the developing roller 25 are configured so that the movement direction of the surface of the toner-supplying roller 34 in the nip portion N and the movement direction of the surface of the developing roller 25 in the nip portion N are opposite to each other at the time of operation (rotation) (counter configuration). That is, the toner-supplying roller 34 and the developing roller 25 are configured so that the movement direction of the surface of the developing roller 25 is opposite to the movement direction of the surface of the toner-supplying roller 34 at a contact position with the toner-supplying roller 34. The toner-supplying roller 34 and the developing roller 25 are in contact with each other in a predetermined penetration amount, that is, a recessed amount AE of a recessed shape in the toner-supplying roller 34 formed by the developing roller 25. It is required that the toner-supplying roller 34 and the developing roller 25 be rotated with the following peripheral velocity difference in directions opposite to each other in the nip portion N. That is, the developing roller 25 and the toner-supplying roller 34 are configured to be rotated while R represented by the following formula (E1) satisfies 1.2≤R≤1.5:

R=V_{RS}/V_{D} (E1)

in the formula (E1), V_{RS} represents the absolute value of the peripheral velocity [m/s] of the toner-supplying roller 34, and V_{D} represents the absolute value of the peripheral velocity [m/s] of the developing roller 25.

Through this operation, toner supply to the developing roller 25 is performed while the residual toner on the developing roller 25 is recovered. In this case, the recovery amount of residual toner on the developing roller 25 and the supply amount of the toner to the developing roller 25 can be adjusted by adjusting a potential difference between the toner-supplying roller 34 and the developing roller 25.

The toner-supplying roller 34 includes, for example, an electroconductive support serving as a shaft body and a foamed layer supported by the electroconductive support. Specifically, there may be arranged a metal core electrode having an outer diameter of φ5 (mm) serving as the electroconductive support and a urethane foamed layer formed around the metal core electrode, a urethane foamed layer serving as the foamed layer including an open-cell foam (open cell) in which bubbles are connected to each other, and the toner-supplying roller 34 is rotated in the direction of the arrow C in the figure at the time of operation. A large amount of the toner is allowed to penetrate into the toner-supplying roller 34 by forming the urethane of the surface layer into an open-cell foam. The resistance of the toner-supplying roller 34 may be, for example, 1×10⁹Ω.

The penetration amount of the toner-supplying roller 34 into the developing roller 25, that is, the recessed amount AE of the recessed shape in the toner-supplying roller 34 formed by the developing roller 25 may be set to, for example, 1.0 mm.

A method of measuring the resistance of the toner-supplying roller 34 is described below. The toner-supplying roller 34 is brought into abutment against an aluminum sleeve having a diameter of 30 mm so that the penetration amount to be described later is 1.5 mm. The toner-supplying roller is rotated following the aluminum sleeve at 30 rpm by rotating the aluminum sleeve.

Next, a DC voltage of −50V is applied to the developing roller 25. In this case, a resistor of 10 kΩ is arranged on the ground side and the voltage at each end of the resistor is measured to calculate a current. Thus, the resistance of the toner-supplying roller 34 is calculated. The surface cell diameter of the toner-supplying roller 34 may be set to, for example, 50 to 1,000 μm.

Herein, the cell diameter refers to the average diameter of foamed cells in an arbitrary cross-section. The average diameter is obtained by first measuring the area of the largest foamed cell from the enlarged image of the arbitrary cross-section, converting the area into a diameter equivalent to a perfect circle to provide a maximum cell diameter, then removing the foamed cells each having a cell diameter equal to or less than ½ of the maximum cell diameter as noise, and then converting the remaining individual cell areas into individual cell diameters in the same manner to provide an average thereof.

The toner supplied from the toner-supplying roller 34 to the surface of the developing roller 25 is frictionally charged by sliding between the developing blade 35 and the developing roller 25 to be given charge and is simultaneously regulated for layer thickness. After that, the toner is conveyed to the abutment portion (developing portion) between the photosensitive drum 1 and the developing roller 25 and is transferred only to the light portion potential portion. The residual toner remaining on the surface of the developing roller 25 is returned into a developing container again and is recovered from the surface of the developing roller 25 by the toner-supplying roller 34 to be stored in the toner-supplying roller 34.

The configuration for driving the developing roller 25 and the toner-supplying roller 34 preferably includes a driving force-receiving portion, a first driving force-transmitting portion, and a second driving force-transmitting portion. In this case, the driving force-receiving portion is configured to receive a driving force for driving the toner-supplying roller 34. In addition, the first driving force-transmitting portion is configured to transmit the driving force received by the driving force-receiving portion to the toner-supplying roller 34. In addition, the second driving force-transmitting portion is configured to transmit the driving force generated by drive of the toner-supplying roller 34 to the developing roller 25. When the rotational drive of the developing roller 25 is indirectly performed through the second driving force-transmitting portion in response to the input of a driving force from the outside, the second driving force-transmitting portion absorbs an abrupt frictional force fluctuation and suppresses the coat amount of the toner on the developing roller 25 from becoming unstable (reference patent literature: Japanese Patent Application Laid-Open No. 2014-134787). Specifically, the developing roller 25 is in contact with both the toner-supplying roller 34 and the photosensitive drum 1, and hence any abrupt frictional force fluctuation that has occurred between the developing roller 25 and the photosensitive drum 1 influences the rotation of the toner-supplying roller 34 that is in contact with the developing roller 25. In addition, the coat amount of the toner supplied onto the developing roller 25 by the toner-supplying roller 34 may become unstable. In the above-mentioned preferred configuration, the toner-supplying roller 34 is first driven by the input of a driving force from the outside, and then the developing roller 25 is driven through the second driving force-transmitting portion. Thus, even when an abrupt frictional force fluctuation occurs between the developing roller 25 and the photosensitive drum 1, the toner-supplying roller 34 is driven with a driving force from the outside that is not influenced by the frictional force fluctuation, and the second driving force-transmitting portion absorbs the frictional force fluctuation. As a result, the toner-supplying roller 34 can stably supply the toner to the developing roller 25. The above-mentioned configuration that suppresses the phenomenon that the abrupt frictional force fluctuation makes the coat amount of the toner unstable is suitable for suppressing banding at the time of repeated use in the present disclosure. The second driving force-transmitting portion may include a third driving force-transmitting portion, a fourth driving force-transmitting portion, and a fifth driving force-transmitting portion. In this case, the third driving force-transmitting portion is arranged in the end portion of the shaft body of the toner-supplying roller 34 and is configured to transmit a driving force generated by drive of the toner-supplying roller 34 to the fourth driving force-transmitting portion. In addition, the fourth driving force-transmitting portion is configured to transmit the driving force to the fifth driving force-transmitting portion by being driven with the driving force received from the third driving force-transmitting portion. In addition, the fifth driving force-transmitting portion is arranged in the end portion of the mandrel of the developing roller 25 and is configured to receive the driving force from the fourth driving force-transmitting portion to drive the developing roller 25.

FIG. 2 is a schematic view for illustrating a specific example of a preferred configuration for driving the developing roller and the toner-supplying roller described above.

The driving force input to a coupling (driving force-receiving portion) 101 is transmitted to a driving force-transmitting member 103 through an intermediate 102 to drive the toner-supplying roller 134 rotationally. In this case, the combination of the intermediate 102 and the driving force-transmitting member 103 corresponds to the first driving force-transmitting portion described above. The rotational driving force transmitted to the toner-supplying roller 134 is transmitted to a gear (third driving force-transmitting portion) 104a, a gear (fourth driving force-transmitting portion) 104b, and a gear (fifth driving force-transmitting portion) 104c in this order to drive the developing roller 125 rotationally. In this case, the configuration formed of the combination of the gear 104a, the gear 104b, and the gear 104c corresponds to the second driving force-transmitting portion described above. That is, the gear 104a is arranged in the end portion of a shaft body 105 of the toner-supplying roller 134, and transmits the driving force generated by drive of the toner-supplying roller 134 to the gear 104b. Subsequently, the gear 104b is driven with the driving force received from the gear 104a to transmit the driving force to the gear 104c. In addition, the gear 104c is arranged in the end portion of a mandrel 106 of the developing roller 125, and receives the driving force from the gear 104b to drive the developing roller 125. As a result, the driving force generated by drive of the toner-supplying roller 134 is transmitted to the developing roller 125. In the example illustrated in FIG. 2, there is looseness in intermeshing portions among the gears 104a, 104b, and 104c, and hence the abrupt frictional force fluctuation that has occurred between the developing roller 125 and the photosensitive drum can be absorbed. In addition, the driving force transmitted from the outside to the toner-supplying roller 134 through the coupling 101, the intermediate 102, and the driving force-transmitting member 103 is not influenced by such frictional force fluctuation, and hence the toner-supplying roller 134 is stably driven. As a result, a fluctuation in supply amount of the toner from the toner-supplying roller 134 to the developing roller 125 can be suppressed.

The specific configuration of the second driving force-transmitting portion is not limited to the configuration formed of the combination of the gears 104a, 104b, and 104c illustrated in FIG. 2. The specific configuration of the second driving force-transmitting portion may be a configuration using any mechanism as long as the configuration is capable of transmitting the driving force generated by drive of the toner-supplying roller 134 to the developing roller 125.

In the preferred configuration for driving the developing roller 125 and the toner-supplying roller 134 described above, the above-mentioned R is required to satisfy 1.2≤R≤1.5. To that end, it is only required that the toner-supplying roller 134, the second driving force-transmitting portion, and the developing roller 125 be driven to be coupled as described below. That is, when the radius of the developing roller 125 is represented by r_{D} [mm] and the radius of the toner-supplying roller 134 is represented by r_{RS} [mm], it is only required that the above-mentioned respective members be driven to be coupled so that λ represented by the following formula (E2) satisfies 1.2≤λ×r_{RS}/r_{D}≤1.5. In this case, λ represented by the following formula (E2) represents the ratio of a rotational angular velocity with respect to the radius r_{D} of the developing roller 125 and the radius r_{RS} of the toner-supplying roller 134:

Δ=ω_{RS}/ω_{D} (E2)

in the formula (E2), ω_{RS} represents the rotational angular velocity [rad/s] of the toner-supplying roller 134, and ω_{D} represents the rotational angular velocity [rad/s] of the developing roller 125.

As an example, in the specific configuration illustrated in FIG. 2, it is only required that the three gear ratios of the gears 104a, 104b, and 104c be set so that the A satisfies 1.2≤λ×r_{RS}/r_{D}≤1.5.

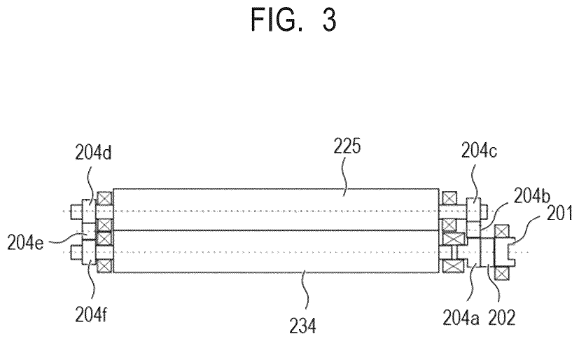

In addition, FIG. 3 is a schematic view for illustrating another example of the configuration for driving the developing roller and the toner-supplying roller.

The driving force input to a coupling 201 is transmitted to a gear 204a through an intermediate 202 and is transmitted to a gear 204b and a gear 204c in this order to drive a developing roller 225 rotationally. The rotational driving force is transmitted to a gear 204d, a gear 204e, and a gear 204f in this order to drive a toner-supplying roller 234 rotationally.

In the present disclosure, the above-mentioned R preferably satisfies 1.2≤R≤1.3 from the viewpoint of suppressing background fogging, a developing ghost, and banding at the time of repeated use in a well-balanced manner.

The process cartridge according to the present disclosure may be used in, for example, a laser beam printer, an LED printer, and a copying machine.

According to the present disclosure, there can be provided a process cartridge capable of suppressing background fogging and a developing ghost and further suppressing the occurrence of banding at the time of repeated use.

### EXAMPLES

The present disclosure is described in more detail below by way of Examples and Comparative Examples. The present disclosure is by no means limited to the following Examples without departing from the gist of the present disclosure. In the description of the following Examples, the term “part(s)” is “part(s) by mass” unless otherwise specified.

The thicknesses of the respective layers of electrophotographic photosensitive members produced in Examples and Comparative Examples except a charge generating layer were each determined by a method including using an eddy current-type thickness meter (Fischerscope (trademark), manufactured by Fischer Instruments K.K.) or a method including converting the mass of the layer per unit area into the thickness thereof through use of the specific gravity thereof. The thickness of the charge generating layer was determined as described below. That is, the Macbeth density value of the photosensitive member was measured by pressing a spectral densitometer (product name: X-Rite 504/508, manufactured by X-Rite Inc.) against the surface of the photosensitive member. Through use of a calibration curve obtained in advance from the Macbeth density value and the value of the thickness measured by the observation of a sectional SEM image of the layer, the thickness was calculated from the measured Macbeth density value.

### <Preparation of Coating Liquid for Undercoat Layer>

100 Parts of rutile-type titanium oxide particles (product name: MT-600B, average primary particle diameter: 50 nm, manufactured by Tayca Corporation) were stirred and mixed with 500 parts of toluene, and 5.0 parts of vinyltrimethoxysilane (product name: KBM-1003, manufactured by Shin-Etsu Chemical Co., Ltd.) was added to the mixture, followed by stirring for 8 hours. After that, toluene was evaporated by distillation under reduced pressure, and the residue was dried at 120° C. for 3 hours. Thus, rutile-type titanium oxide particles whose surfaces had already been treated with vinyltrimethoxysilane were obtained.

Subsequently, the following materials were prepared.
The rutile-type titanium oxide particles whose surfaces had already been treated with vinyltrimethoxysilane, which were obtained in the foregoing: 18 parts
N-Methoxymethylated nylon (product name: TORESIN EF-30T, manufactured by Nagase ChemteX Corporation): 4.5 parts
A copolymerized nylon resin (product name: AMILAN (trademark) CM8000, manufactured by Toray Industries, Inc.): 1.5 parts

Those materials were added to a mixed solvent of 90 parts of methanol and 60 parts of 1-butanol to prepare a dispersion liquid. The dispersion liquid was subjected to dispersion treatment for 5 hours with a vertical sand mill through use of glass beads each having a diameter of 1.0 mm to prepare a coating liquid for an undercoat layer.

### <Preparation of Coating Liquid for Charge Generating Layer>

### Synthesis Example

In 100 g of α-chloronaphthalene, 5.0 g of o-phthalodinitrile and 2.0 g of titanium tetrachloride were heated and stirred at 200° C. for 3 hours, and were then cooled to 50° C. to precipitate a crystal. The crystal was separated by filtration to provide a paste of dichlorotitanium phthalocyanine. Next, the paste was stirred and washed with 100 mL of N,N-dimethylformamide heated to 100° C., and was then washed repeatedly twice with 100 mL of methanol at 60° C. and separated by filtration. Further, the resultant paste was stirred at 80° C. for 1 hour in 100 mL of deionized water, and was separated by filtration to provide 4.3 g of a blue titanyl phthalocyanine pigment.

### Milling Example

0.5 Part of the titanyl phthalocyanine pigment obtained in Synthesis Example, 10 parts of tetrahydrofuran, and 15 parts of glass beads each having a diameter of 0.9 mm were subjected to milling treatment with a sand mill (K-800, manufactured by Igarashi Machine Production Co., Ltd. (currently changed to Aimex Co., Ltd.), disc diameter: 70 mm, number of discs: 5) under a cooling water temperature of 18° C. for 48 hours. At this time, the treatment was performed under such a condition that the discs were rotated 500 times per minute. The glass beads were removed by filtering the liquid thus treated with a filter (product number: N-NO. 125T, pore diameter: 133 μm, manufactured by NBC Meshtec Inc.). 30 Parts of tetrahydrofuran was added to the resultant liquid, and then the mixture was filtered, followed by sufficient washing of the filtration residue on the filter with methanol and water. Then, the washed filtration residue was dried in a vacuum to provide 0.45 part of a titanyl phthalocyanine pigment. The resultant pigment had a strong peak at a Bragg angle 2θ of 27.2°±0.3° in an X-ray diffraction spectrum using a CuKα ray.

The following materials were prepared.
The titanyl phthalocyanine pigment obtained in Milling Example: 12 parts
Polyvinyl butyral (product name: S-LEC BX-1, manufactured by Sekisui Chemical Co., Ltd.): 10 parts
Cyclohexanone: 158 parts
Glass beads each having a diameter of 0.9 mm: 402 parts

Those materials were subjected to dispersion treatment with a sand mill (K-800, manufactured by Igarashi Machine Production Co., Ltd. (currently changed to Aimex Co., Ltd.), disc diameter: 70 mm, number of discs: 5) under a cooling water temperature of 18° C. for 4 hours. At this time, the treatment was performed under such a condition that the discs were rotated 1,800 times per minute. After the removal of the glass beads, 369 parts of cyclohexanone and 527 parts of ethyl acetate were added to the dispersion liquid to prepare a coating liquid for a charge generating layer.

### <Production Example of Polycarbonate Resin>

Monomers used in the production of a polycarbonate resin are classified into CTB monomers 1 to 5 and described below. The CTB monomers 1 and 2 are each a monomer for forming a structural unit that does not correspond to any of the structural unit represented by the formula (A1) or the structural unit represented by the formula (A4). In addition, the CTB monomers 3 and 4 are each a monomer for forming the structural unit represented by the formula (A1). In addition, the CTB monomer 5 is a monomer for forming the structural unit represented by the formula (A4).

### [Production Example of Polycarbonate Resin P1]

The following CTB monomers were prepared.
Compound represented by the following formula (B1) serving as the CTB monomer 1:677 g (2.52 mol)

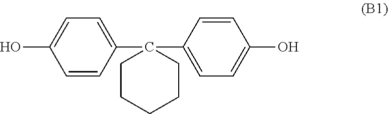 [SMILES: Oc1ccc(C2(c3ccc(O)cc3)CCCCC2)cc1]

Compound represented by the following formula (B2) serving as the CTB monomer 3:180 g (0.84 mol)

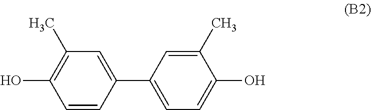 [SMILES: Cc1cc(-c2ccc(O)c(C)c2)ccc1O]

Compound represented by the following formula (B3) serving as the CTB monomer 5:180 g (0.84 mol)

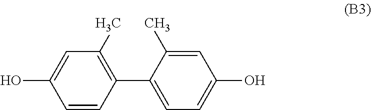 [SMILES: Cc1cc(O)ccc1-c1ccc(O)cc1C]

Nothing was used as each of the CTB monomers 2 and 4.

The above-mentioned respective monomers, 0.4 g of triethylbenzylammonium chloride, and 5.0 g of hydrosulfite were dissolved in 5.4 L of a 9.0 w/w % sodium hydroxide (NaOH) aqueous solution. 2.4 L of methylene chloride was added to the solution, and the temperature of the mixture was maintained at 15° C. while the mixture was stirred. Subsequently, during the temperature maintenance, 540 g of phosgene was blown into the mixture over 30 minutes. After the completion of the blowing of phosgene, 21 g of p-t-butylphenol was added to the reaction liquid, and the reaction liquid was vigorously stirred to be emulsified. After the emulsification, 11 ml of triethylamine was added to the emulsified product, and the mixture was stirred at a temperature of 20 to 25° C. for about 1 hour to be polymerized.

After the completion of the polymerization, the reaction liquid was separated into an aqueous phase and an organic phase, and the organic phase was neutralized with phosphoric acid. The organic phase was repeatedly washed with water until the conductivity of washing water became 10 μS/cm or less. The resultant organic phase was dropped into warm water kept at 62° C., and the solvent was removed by evaporation. Thus, a white powdery precipitate was obtained. The resultant precipitate was filtered out, and was dried at a temperature of 120° C. for 24 hours to provide a target polycarbonate resin P1.

### [Production Examples of Polycarbonate Resins P2 to P47]

Polycarbonate resins P2 to P47 were produced in the same manner as in the polycarbonate resin P1 except that in the production example of the polycarbonate resin P1, the CTB monomers used were changed to compounds shown in Table 1, and the compounds were used at molar ratios shown in Table 1. B4 to B10 in Table 1 correspond to compounds represented by the following formulae (B4) to (B10), respectively.

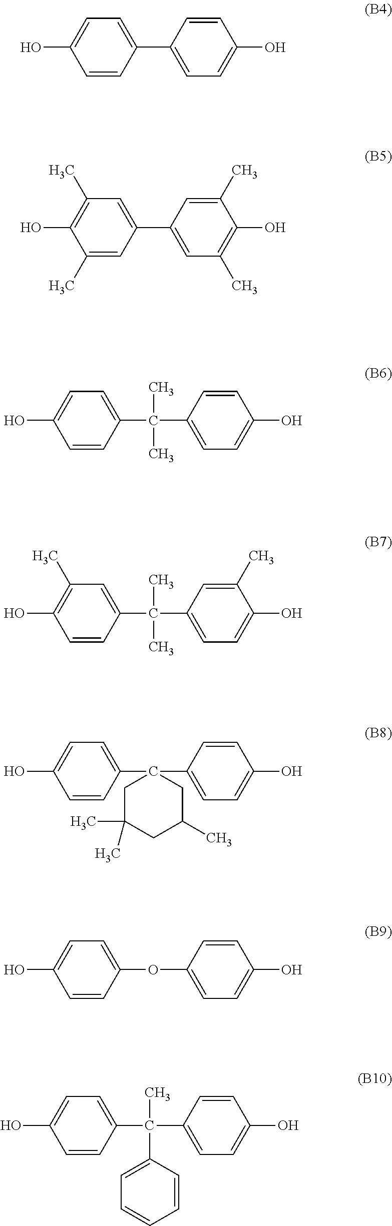

TABLE 1

| | Kind of compound and copolymerization unit ratio of CTB monomer/mol % | | | | | | | | | |
|---|---|---|---|---|---|---|---|---|---|---|
| Polycarbonate | CTB | | CTB | | CTB | | CTB | | CTB | |
| resin | monomer 1 | | monomer 2 | | monomer 3 | | monomer 4 | | monomer 5 | |
| P1 | B1 | 60% | — | — | B2 | 20% | — | — | B3 | 20% |
| P2 | B1 | 60% | — | — | B4 | 20% | — | — | B3 | 20% |
| P3 | B1 | 60% | — | — | B5 | 20% | — | — | B3 | 20% |
| P4 | B1 | 70% | — | — | B2 | 23% | — | — | B3 | 7% |
| P5 | B1 | 68% | — | — | B2 | 23% | — | — | B3 | 9% |
| P6 | B1 | 67% | — | — | B2 | 22% | — | — | B3 | 11% |
| P7 | B1 | 64% | — | — | B2 | 21% | — | — | B3 | 15% |
| P8 | B1 | 53% | — | — | B2 | 18% | — | — | B3 | 29% |
| P9 | B1 | 50% | — | — | B2 | 16% | — | — | B3 | 34% |
| P10 | B1 | 84% | — | — | B2 | 8% | — | — | B3 | 8% |
| P11 | B1 | 72% | — | — | B2 | 14% | — | — | B3 | 14% |
| P12 | B1 | 64% | — | — | B2 | 18% | — | — | B3 | 18% |
| P13 | B1 | 52% | — | — | B2 | 24% | — | — | B3 | 24% |
| P14 | B1 | 89% | — | — | B2 | 8% | — | — | B3 | 3% |
| P15 | B1 | 75% | — | — | B4 | 25% | — | — | — | — |
| P16 | B1 | 75% | — | — | B5 | 25% | — | — | — | — |
| P17 | B1 | 96% | — | — | B4 | 4% | — | — | — | — |
| P18 | B1 | 90% | — | — | B4 | 10% | — | — | — | — |
| P19 | B1 | 80% | — | — | B4 | 20% | — | — | — | — |
| P20 | B1 | 70% | — | — | B4 | 30% | — | — | — | — |
| P21 | B1 | 75% | — | — | B2 | 25% | — | — | — | — |
| P22 | B1 | 92% | — | — | B2 | 8% | — | — | — | — |
| P23 | B1 | 92% | — | — | B5 | 8% | — | — | — | — |
| P24 | B1 | 53% | — | — | B2 | 18% | B4 | 11% | B3 | 18% |
| P25 | B1 | 64% | — | — | B2 | 22% | B4 | 14% | — | — |
| P26 | B1 | 44% | B6 | 18% | B2 | 19% | — | — | B3 | 19% |
| P27 | B1 | 52% | — | — | B2 | 24% | — | — | B3 | 24% |
| P28 | B6 | 100% | — | — | — | — | — | — | — | — |
| P29 | B1 | 53% | B6 | 23% | B2 | 24% | — | — | — | — |
| P30 | B1 | 69% | — | — | B2 | 31% | — | — | — | — |
| P31 | B7 | 100% | — | — | — | — | — | — | — | — |
| P32 | B6 | 70% | — | — | B2 | 15% | — | — | B3 | 15% |
| P33 | B7 | 70% | — | — | B2 | 15% | — | — | B3 | 15% |
| P34 | B1 | 54% | B6 | 23% | B4 | 23% | — | — | — | — |
| P35 | B1 | 70% | — | — | B4 | 30% | — | — | — | — |
| P36 | B1 | 55% | B7 | 21% | B4 | 24% | — | — | — | — |
| P37 | B6 | 82% | — | — | B4 | 18% | — | — | — | — |
| P38 | B1 | 100% | — | — | — | — | — | — | — | — |
| P39 | B7 | 82% | — | — | B4 | 18% | — | — | — | — |
| P40 | B1 | 75% | — | — | — | — | — | — | B3 | 25% |
| P41 | B1 | 50% | B6 | 50% | — | — | — | — | — | — |
| P42 | B1 | 56% | B8 | 44% | — | — | — | — | — | — |
| P43 | B1 | 50% | B9 | 50% | — | — | — | — | — | — |
| P44 | B6 | 78% | — | — | — | — | — | — | B3 | 22% |
| P45 | B6 | 50% | B7 | 50% | — | — | — | — | — | — |
| P46 | B6 | 50% | B8 | 50% | — | — | — | — | — | — |
| P47 | B7 | 50% | B10 | 50% | — | — | — | — | — | — |

### <Preparation of Coating Liquid for Charge Transporting Layer>

A resin used in the preparation of a coating liquid for a charge transporting layer is described below. In the case of using one kind of resin, the resin is referred to as “resin 1”, and in the case of using two kinds of resins, the resins are referred to as “resin 1” and “resin 2”.

### [Preparation of Coating Liquid 1 for Charge Transporting Layers]

7 Parts of the CTM 10 serving as a charge transporting substance and 10 parts of the polycarbonate resin P1 serving as the resin 1 were dissolved in a mixed solvent of 55 parts of toluene and 45 parts of tetrahydrofuran to prepare a coating liquid 1 for a charge transporting layer.

[Preparation of Coating Liquids 2 to 60 for Charge Transporting Layer]

In the preparation of the coating liquid 1 for a charge transporting layer, the kinds of the charge transporting substance and the resin to be used were changed to compounds shown in Tables 2 and 3, and the D/B ratio that was a mass ratio between the charge transporting substance and the resin (total of the resin 1 and the resin 2) was changed as shown in Tables 2 and 3. In addition, the ratio M [mol %] of copolymerization units in the resin 2 with respect to the total ratio of 100 mol % of various copolymerization units in the resin 1 was changed as shown in Tables 2 and 3. Coating liquids 2 to 60 for charge transporting layers were each prepared in the same manner as in the coating liquid 1 for a charge transporting layer except the foregoing. In this case, the term “PAR” in Table 3 refers to a polyarylate resin including a structural unit represented by the following formula (B11) and a structural unit represented by the following formula (B12) at a molar ratio of 1.2:0.9.

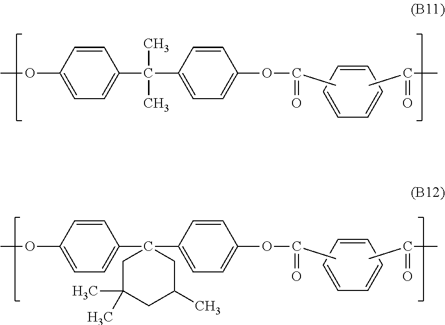

TABLE 2

| Coating liquid | Charge | | | | |
|---|---|---|---|---|---|
| No. for charge | transporting | D/B | | | |
| transporting layer | substance | ratio | Resin 1 | Resin 2 | M/mol % |
| 1 | CTM10 | 7/10 | P1 | — | — |
| 2 | CTM10 | 7/10 | P2 | — | — |
| 3 | CTM10 | 7/10 | P3 | — | — |
| 4 | CTM10 | 7/10 | P4 | — | — |
| 5 | CTM10 | 7/10 | P5 | — | — |
| 6 | CTM10 | 7/10 | P6 | — | — |
| 7 | CTM10 | 7/10 | P7 | — | — |
| 8 | CTM10 | 7/10 | P8 | — | — |
| 9 | CTM10 | 7/10 | P9 | — | — |
| 10 | CTM10 | 7/10 | P10 | — | — |
| 11 | CTM10 | 7/10 | P11 | — | — |
| 12 | CTM10 | 7/10 | P12 | — | — |
| 13 | CTM10 | 7/10 | P13 | — | — |
| 14 | CTM10 | 7/10 | P14 | — | — |
| 15 | CTM10 | 7/10 | P15 | — | — |
| 16 | CTM10 | 7/10 | P16 | — | — |
| 17 | CTM10 | 7/10 | P17 | — | — |
| 18 | CTM10 | 7/10 | P18 | — | — |
| 19 | CTM10 | 7/10 | P19 | — | — |
| 20 | CTM10 | 7/10 | P20 | — | — |
| 21 | CTM10 | 7/10 | P21 | — | — |
| 22 | CTM10 | 7/10 | P22 | — | — |
| 23 | CTM10 | 7/10 | P23 | — | — |
| 24 | CTM10 | 6/10 | P1 | — | — |
| 25 | CTM1 | 7/10 | P1 | — | — |
| 26 | CTM10 | 6/10 | P15 | — | — |
| 27 | CTM1 | 7/10 | P15 | — | — |
| 28 | CTM10 | 6/10 | P21 | — | — |
| 29 | CTM1 | 7/10 | P21 | — | — |
| 30 | CTM10 | 7/10 | P24 | — | — |
| 31 | CTM10 | 7/10 | P25 | — | — |
| 32 | CTM10 | 6/10 | P25 | — | — |
| 33 | CTM1 | 7/10 | P25 | — | — |

TABLE 3

| Coating liquid No. for | Charge | | | | |
|---|---|---|---|---|---|
| charge transporting | transporting | D/B | Resin | Resin | |
| layer | substance | ratio | 1 | 2 | M/mol % |
| 34 | CTM10 | 7/10 | P26 | — | — |
| 35 | CTM10 | 7/10 | P27 | P28 | 22% |
| 36 | CTM10 | 7/10 | P29 | — | — |
| 37 | CTM10 | 7/10 | P30 | P28 | 29% |
| 38 | CTM10 | 7/10 | P26 | P31 | 16% |
| 39 | CTM10 | 7/10 | P32 | — | — |
| 40 | CTM10 | 7/10 | P33 | — | — |
| 41 | CTM10 | 7/10 | P34 | — | — |
| 42 | CTM10 | 7/10 | P35 | P28 | 30% |
| 43 | CTM10 | 7/10 | P34 | P31 | 20% |
| 44 | CTM10 | 7/10 | P36 | — | — |
| 45 | CTM10 | 7/10 | P37 | — | — |
| 46 | CTM10 | 7/10 | P37 | P38 | 41% |
| 47 | CTM10 | 7/10 | P39 | — | — |
| 48 | CTM10 | 7/10 | P39 | P38 | 41% |
| 49 | CTM10 | 7/10 | P35 | PAR | 29% |
| 50 | CTM10 | 7/10 | P40 | — | — |
| 51 | CTM10 | 7/10 | P41 | — | — |
| 52 | CTM10 | 7/10 | P42 | P28 | 56% |
| 53 | CTM10 | 7/10 | P43 | — | — |
| 54 | CTM10 | 7/10 | P28 | — | — |
| 55 | CTM10 | 7/10 | P44 | — | — |
| 56 | CTM10 | 7/10 | P31 | — | — |
| 57 | CTM10 | 7/10 | P45 | — | — |
| 58 | CTM10 | 7/10 | P46 | — | — |
| 59 | CTM10 | 7/10 | P47 | — | — |
| 60 | CTM10 | 6/10 | P28 | — | — |

### <Production of Electrophotographic Photosensitive Member>

### (Photosensitive Member Production Example 1)

An aluminum cylinder (JIS-A3003, aluminum alloy) having a length of 257 mm and a diameter of 24 mm was obtained as a support by a production method including an extruding step and a drawing step.

The coating liquid for an undercoat layer was applied onto the support by dip coating to form a coating film, and the coating film was dried by heating at 100° C. for 10 minutes to form an undercoat layer having a thickness of 4.0 μm.

Next, the coating liquid for a charge generating layer was applied onto the above-mentioned undercoat layer by dip coating to form a coating film, and the coating film was dried by heating at 100° C. for 10 minutes to form a charge generating layer having a thickness of 0.22 μm.

Next, the coating liquid 1 for a charge transporting layer was applied onto the above-mentioned charge generating layer by dip coating to form a coating film, and the coating film was dried by heating at a temperature of 120° C. for 60 minutes to form a charge transporting layer having a thickness of 23 μm.

The heating treatment of the coating film of each layer was performed with an oven set to each temperature. Thus, a cylindrical (drum-shaped) photosensitive member 1 was produced.

### (Photosensitive Member Production Examples 2 to 60)

Photosensitive members 2 to 60 were produced in the same manner as in Photosensitive Member Production Example 1 except that in Photosensitive Member Production Example 1, the kind of the coating liquid for a charge transporting layer to be used was changed to the coating liquids 2 to 60 for charge transporting layers.

### <Production of Developing Roller 1>

### (Preparation of Substrate)

A mandrel made of stainless steel (SUS304) having an outer diameter of 6 mm and a length of 270 mm was prepared, and an electroconductive vulcanizing adhesive (product name: METALOC U-20, manufactured by Toyokagaku Kenkyusho Co., Ltd.) was applied to the circumferential surface of the mandrel, followed by baking. Thus, a mandrel serving as a substrate was prepared.

### (Formation of First Elastic Layer)

Materials for elastic layers shown in Table 4 were mixed at a filling ratio of 70 vol % and a blade rotation speed of 30 rpm for 16 minutes with a 6-liter pressure kneader (product name: TD6-15MDX, manufactured by TOSHIN Co., Ltd.) to provide a mixture A.

TABLE 4

| | Part(s) by |
|---|---|
| Material | mass |
| Acrylonitrile-butadiene rubber (NBR) | 60 |
| (product name: N230SV, manufactured by | |
| JSR Corporation) | |
| Epichlorohydrin rubber | 40 |
| (product name: EPION 301, manufactured by | |
| Osaka Soda Co., Ltd.) | |
| Zinc oxide (particle diameter: 0.28 μm, | 5 |
| manufactured by Sakai Chemical Industry | |
| Co., Ltd.) | |
| Calcium carbonate | 20 |
| (product name: NANOX #30, manufactured | |
| by Maruo Calcium Co., Ltd.) | |
| Carbon black | 40 |
| (product name: TOKABLACK #7400, manufactured | |
| by Tokai Carbon Co., Ltd.) | |

Then, materials shown in Table 5 were bilaterally cut 20 times in total at a front roll rotation speed of 10 rpm, a back roll rotation speed of 8 rpm, and a roll gap of 2 mm with an open roll having a roll diameter of 12 inches (0.30 m). After that, the resultant was subjected to tight milling 10 times at a roll gap of 0.5 mm to provide a mixture B.

TABLE 5

| Material | Part(s) by mass |
|---|---|
| Mixture A | 200 |
| Sulfur | 1.2 |
| Tetrabenzylthiuram disulfide | 4.5 |
| (product name: NOCCELER TBzTD, manufactured | |
| by Ouchi Shinko Chemical Industrial Co., Ltd.) | |

Next, the above-mentioned mixture B was extruded simultaneously with the mandrel while being molded into a cylindrical shape coaxially around the mandrel by extrusion molding using a crosshead. Thus, a layer of the mixture B was formed on the outer peripheral surface of the mandrel. An extruder having a cylinder diameter of 45 mm (Φ45) and an L/D of 20 was used as an extruder, and the temperatures of a head, a cylinder, and a screw at the time of the extrusion were adjusted to 90° C., 90° C., and 90° C., respectively. Both the end portions of the layer of the mixture B in the longitudinal direction of the mandrel were cut so that the length of the layer of the mixture B in the longitudinal direction of the mandrel was set to 237 mm.

After that, the mandrel was heated in an electric furnace at a temperature of 160° C. for 40 minutes so that the layer of the mixture B was vulcanized. Thus, a vulcanized member was formed. Subsequently, the surface of the vulcanized member was polished with a polishing machine of a plunge-cut grinding mode. Thus, a roller in which a first elastic layer having a thickness of 3.0 mm was formed on the outer periphery of a metal core was obtained.

### (Formation of Second Elastic Layer)

Materials except roughness-forming particles in Table 6 were stirred and mixed as materials for a second elastic layer. After that, the materials were dissolved in methyl ethyl ketone (manufactured by Kishida Chemical Co., Ltd.) so that their solid content concentration was 30 mass %, and the materials were mixed, followed by uniform dispersion with a sand mill. Methyl ethyl ketone was added to the mixed liquid to adjust the solid content concentration to 25 mass %, and a material shown in the “Roughness-forming particles” column of Table 6 was added to the resultant mixture, followed by stirring and dispersion with a ball mill. Thus, a coating liquid for a second elastic layer was obtained. The coating liquid was applied to the roller having the first elastic layer formed thereon by dipping the roller into the coating liquid so that the thickness of the second elastic layer was about 15 μm. After that, the coating film was dried and cured by heating at a temperature of 135° C. for 60 minutes to form a second elastic layer. Thus, a developing roller 1 was obtained.

TABLE 6

| | Part(s) |
|---|---|
| Material | by mass |
| Polyether polyol | 100 |
| (product name: PTGL1000, manufactured by Hodogaya | |
| Chemical Co., Ltd.) | |
| Polymeric MDI | 36.0 |
| (product name: MR-400, manufactured by Tosoh | |
| Corporation) | |
| Carbon black | 29.3 |
| (product name: SUNBLACK X15, manufactured by | |
| Asahi Carbon Co., Ltd.) | |
| Polyether monool | 3.0 |
| (product name: Newpol 50HB100, manufactured by | |
| Sanyo Chemical Industries, Ltd.) | |
| Modified silicone oil | 0.6 |
| (product name: TSF4445, manufactured by Momentive | |
| Performance Materials Japan LLC) | |
| Roughness-forming particles | 104 |
| (product name: DAIMIC BEAZ UCN-5090, manufactured by | |
| Dainichiseika Color & Chemicals Mfg. Co., Ltd.) | |

### (Analysis of Developing Roller 1)

The developing roller 1 was left to stand under an environment at a temperature of 23° C. and a relative humidity of 53% for 24 hours. Next, the hardness of the developing roller was measured with a microrubber hardness meter (product name: MD-1capa, manufactured by Kobunshi Keiki Co., Ltd.) and an indenter having a diameter of 0.16 mm at each of 12 points determined as follows: the central portion of the developing roller and positions distant inward from both the end portions thereof by 20 mm each were determined, and four points were determined in each of the three portions in increments of 90° in the circumferential direction thereof. The average of those measured values was adopted as an MD-1 hardness. The developing roller 1 showed an MD-1 hardness of 50°.

### <Production of Toner-supplying Roller 1>

A primer (product name: DY39-012, manufactured by Dow Corning Toray Co., Ltd.) was applied to a metal core made of stainless steel (SUS304) having a diameter of 5 mm, followed by baking, to prepare a shaft body.

In addition, a urethane rubber composition obtained by blending the following materials (A) to (F) and mixing the blended materials was foamed by a mechanical frothing method to produce a polyurethane foam.

The polyurethane foam was cut out into a 19-millimeter square rectangular parallelepiped shape having a length of 220 mm, and a shaft body insertion hole having a diameter of Φ5 mm was formed at the center of the 19-millimeter square surface along a longitudinal direction.

The shaft body was press-fitted into the shaft body insertion hole, and the shaft body and the polyurethane foam were bonded to each other by heat welding.

After that, the outer periphery of the polyurethane foam was polished with a traverse-type processing machine to produce an electroconductive roll having an outer diameter of 13 mm.
(A): Carbon black (Ketjen Black 600JD): 5.0 parts by mass
(B): Polyol A (polyethylene propylene ether triol having a number average molecular weight of 2,000, product name: ACTCOL EP-550N, manufactured by Mitsui Chemicals, Inc.): 100.0 parts by mass
(C): Polyisocyanate mixture (NCO %=45, MDI=20% content, product name: COSMONATE TM20, manufactured by Mitsui Chemicals, Inc.): 24.4 parts by mass
(D): Silicone foam stabilizer (product name: SRX274C, manufactured by Dow Corning Toray Silicone Co., Ltd.): 1.0 part by mass
(E): Tertiary amine catalyst A (mixture of bis(2-dimethylaminoethyl) ether and dipropylene glycol, product name: TOYOCAT-ET, manufactured by Tosoh Corporation): 0.3 part by mass
(F): Amine catalyst B (product name: TOYOCAT-L33, manufactured by Tosoh Corporation): 0.2 part by mass

### [Evaluation]

<Process Cartridge used for Evaluation>

Each of the above-mentioned photosensitive members 1 to 60, the developing roller 1, and the toner-supplying roller 1 were mounted on the process cartridge schematically illustrated in FIG. 1.

The following 15 kinds of process cartridges were each prepared as the process cartridge on which each of the above-mentioned photosensitive members was mounted.

First, the coupling 101, the intermediate 102, the driving force-transmitting member 103, and the gears 104a to 104c were arranged as illustrated in FIG. 2. Thus, a driving force input from the outside was configured to be input to the end portion of the shaft body 105 of the toner-supplying roller 134 through the coupling 101, the intermediate 102, and the driving force-transmitting member 103 (hereinafter referred to as “RS input configuration”). In addition, the developing roller 125 and the toner-supplying roller 134 were configured so that the movement direction of the surface of the developing roller 125 and the movement direction of the surface of the toner-supplying roller 134 were opposite to each other at a contact position between the developing roller 125 and the toner-supplying roller 134 (counter configuration). Further, to set R determined by a ratio between the peripheral velocity V_{D} of the developing roller 125 and the peripheral velocity V_{RS} of the toner-supplying roller 134 to an intended value, the gear ratios of the respective gears 104a to 104c, the radius r_{D} of the developing roller 125, and the radius r_{RS} of the toner-supplying roller 134, the gears and the rollers being illustrated in FIG. 2, were appropriately set. Specifically, the gear ratios of the respective gears 104a to 104c, the radius r_{D} of the developing roller 125, and the radius r_{RS} of the toner-supplying roller 134, the gears and the rollers being illustrated in FIG. 2, were set so that the R had the following seven kinds of values: 1.15, 1.20, 1.25, 1.30, 1.40, 1.50, and 1.60. Thus, seven kinds of process cartridges were prepared.

Next, the coupling 201, the intermediate 202, and the gears 204a to 204f were arranged as illustrated in FIG. 3. Thus, a driving force from the coupling 201 was configured to be input to the end portion of a mandrel 206 of the developing roller 225 through the coupling 201, the intermediate 202, and the gears 204a to 204c (hereinafter referred to as “D input configuration”). In addition, the developing roller 225 and the toner-supplying roller 234 were configured so that the movement direction of the surface of the developing roller 225 and the movement direction of the surface of the toner-supplying roller 234 were opposite to each other at a contact position between the developing roller 225 and the toner-supplying roller 234 (counter configuration). Further, to set R determined by a ratio between the peripheral velocity V_{D} of the developing roller 225 and the peripheral velocity V_{RS} of the toner-supplying roller 234 to an intended value, the gear ratios of the respective gears 204a to 204f, the radius r_{D} of the developing roller 225, and the radius r_{RS} of the toner-supplying roller 234, the gears and the rollers being illustrated in FIG. 3, were appropriately set. Specifically, the gear ratios of the respective gears 204a to 204f, the radius r_{D} of the developing roller 225, and the radius r_{RS} of the toner-supplying roller 234, the gears and the rollers being illustrated in FIG. 3, were set so that the R had the following five kinds of values: 1.20, 1.25, 1.30, 1.40, and 1.50. Thus, five kinds of process cartridges were prepared.

Next, in the RS input configuration illustrated in FIG. 2, the number of the gears to be used was changed. Thus, the movement direction of the surface of the developing roller and the movement direction of the surface of the toner-supplying roller were set to be identical with each other at the contact position between the developing roller 125 and the toner-supplying roller 134 (hereinafter referred to as “with configuration”). In addition, the gear ratios of the respective gears (not shown), the radius r_{D} of the developing roller 125, and the radius r_{RS} of the toner-supplying roller 134 were set so that the R determined by the ratio between the peripheral velocity V_{D} of the developing roller 125 and the peripheral velocity V_{RS} of the toner-supplying roller 134 was 1.25. Thus, one kind of process cartridge was prepared.

Next, in the D input configuration illustrated in FIG. 3, the number of the gears was changed. Thus, the movement direction of the surface of the developing roller 225 and the movement direction of the surface of the toner-supplying roller 234 were set to be identical with each other at the contact position between the developing roller 225 and the toner-supplying roller 234 (with configuration). In addition, the gear ratios of the respective gears (not shown), the radius r_{D} of the developing roller 225, and the radius r_{RS} of the toner-supplying roller 234 were set so that the R determined by the ratio between the peripheral velocity V_{D} of the developing roller 225 and the peripheral velocity V_{RS} of the toner-supplying roller 234 had the following two kinds of values: 1.25 and 1.60. Thus, two kinds of process cartridges were prepared.

### <Evaluation>

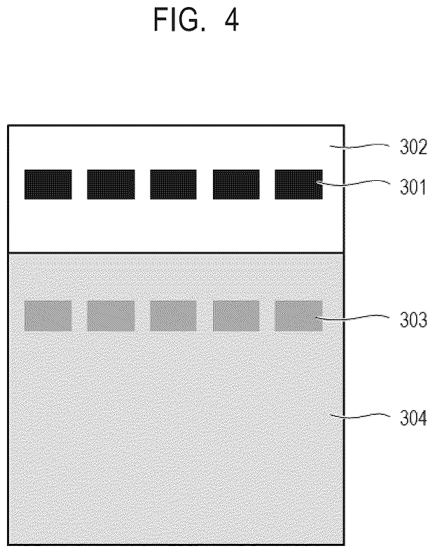

A charging potential and an exposure potential were set to −550 V and −100 V, respectively, under an environment at a temperature of 23° C. and a relative humidity of 50%, and 10,000 sheets were continuously passed so that a halftone image drawing horizontal lines with a width of one dot and intervals of two dots in a direction perpendicular to the rotation direction of the photosensitive member was printed on the sheets. Before and after the passage (printing), a solid white image (non-exposure image), such an image as illustrated in FIG. 4, and the halftone image drawing horizontal lines with a width of one dot and intervals of two dots in a direction perpendicular to the rotation direction of the photosensitive member were each printed on 10 sheets. The image illustrated in FIG. 4 is an image in which solid portions 301 and a solid white portion 302 are located adjacent to each other in the front end of paper, followed by a halftone portion 304 of a one-dot keima (knight of Japanese chess)-jump patterns. In this case, a reconstructed machine of a laser beam printer manufactured by Hewlett-Packard Company was used as an electrophotographic apparatus. Specific examples of the electrophotographic apparatus that may be used in the evaluation of this Example include reconstructed machines of Color Laser Jet Enterprise M653dn (product name), Color Laser Jet Enterprise M553dn (product name), and Color Laser Jet CP4525dn (product name).

Each image rank was determined based on the following criteria by visually observing the three kinds of images before and after the above-mentioned passage (printing).

### (Background Fogging)

The whiteness degree of the printed solid white image (non-exposure image) and the whiteness degree of paper used for the printing were each measured with a fogging measuring device (product name: REFLECTOMETER MODEL TC-6DS, manufactured by Tokyo Denshoku Co., Ltd.), and a fogging density [%] was calculated from a difference therebetween. In this case, an amberlite filter was used as a filter.

The values of the fogging densities [%] were ranked as described below. In this case, the largest of the values of the fogging densities [%] obtained from the 10 sheets of each image was ranked.
A: Less than 0.5%
B: 0.5% or more and less than 1.5%
C: 1.5% or more and less than 3.0%
D: 3.0% or more

### (Developing Ghost)

Such image as illustrated in FIG. 4 in which the solid portions 301 and the solid white portion 302 were located adjacent to each other in the front end of paper, followed by the halftone portion 304 of a one-dot keima (knight of Japanese chess)-jump patterns, the image having been printed, was measured for its image density with a spectral densitometer (product name: X-Rite 504/508, manufactured by X-Rite Inc.). The measurement of the image density was performed for each of the solid portions 301 and ghost portions 303. The ghost portions 303 are portions which are distant from the solid portions 301 by the peripheral length of the developing roller, and in which a developing ghost due to the solid portions 301 may appear. Then, a ghost density was calculated from a difference between the measured value obtained in the solid portions 301 and the measured value obtained in the ghost portions 303.

The values of the ghost densities were ranked as described below. In this case, the largest of the values of the ghost densities obtained from the 10 sheets of each image was ranked.
A: Less than 0.020
B: 0.020 or more and less than 0.030
C: 0.030 or more and less than 0.040
D: 0.040 or more

### (Banding)

The halftone image drawing horizontal lines with a width of one dot and intervals of two dots in a direction perpendicular to the rotation direction of the photosensitive member, the image having been printed, was visually observed.

The results grasped by the visual observation for streak-like unevenness appearing on the above-mentioned halftone image and extending to both the ends of an image area in the axis direction of the photosensitive drum were ranked as described below. In this case, the image in which the streak-like unevenness was most conspicuously observed in the 10 sheets of the image was ranked.
A: No streak-like unevenness is recognized.
B: Streak-like unevenness is slightly recognized.
C: One or two lines of streak-like unevenness are recognized.
D: Three or more lines of streak-like unevenness are recognized.

### (Banding Under High-Temperature and High-Humidity)

Banding under high-temperature and high-humidity was evaluated in the same manner as in the above-mentioned section (Banding) and was also ranked in the same manner as in the section except that the above-mentioned 10,000 sheet passing (printing) and the banding evaluation after the sheet passing (printing) were performed under an environment at a temperature of 31.5° C. and a relative humidity of 80%.

### Example 1

The photosensitive member 1 was mounted on a process cartridge configured so as to have the counter configuration and the RS input configuration, and satisfy R=1.25, and the above-mentioned evaluations were performed. The gear ratios of various gears was set so that λ, which was determined by the following formula (E2) from the rotational angular velocity OD of the developing roller used at this time and the rotational angular velocity ω_{RS} of the toner-supplying roller used at this time, satisfied λ=1.12.

λ=ω_{RS}/ω_{D} (E2)

In addition, the radius r_{D} of the developing roller used at this time was r_{D}=12.00 [mm], and the radius IRS of the toner-supplying roller used at this time was r_{RS}=13.35 [mm]. When those values are used, Δ×r_{RS}/r_{D}=1.25 is established, and the condition of 1.2≤λ×r_{RS}/r_{D}≤1.5 is satisfied.

The obtained results are shown in Table 7.

### Examples 2 to 64 and Comparative Examples 1 to 19

The evaluations of each of Examples 2 to 64 and Comparative Examples 1 to 19 were performed in the same manner as in Example 1 except that in Example 1, the photosensitive member to be used and the configurations of the process cartridge to be used were changed as shown in Tables 7 to 9. The results are shown in Tables 7 to 9.

In Tables 7 to 9, the term “P/mol %” refers to the ratio (mol %) of the content of the structural unit represented by the formula (A4) with respect to the total of the content of the structural unit represented by the formula (A1) and the content of the structural unit represented by the formula (A4) in the surface layer of the photosensitive member 1. In addition, the term “Q/mass %” refers to the content mass of the polycarbonate resin including the structural unit represented by the formula (A1) with respect to the total mass of the surface layer in the surface layer of the photosensitive member 1.

TABLE 7

| | | | | | | Configuration | | | | | |
|---|---|---|---|---|---|---|---|---|---|---|---|
| | | | | | | of movement | | | | | Banding |
| | Photo- | | | | | direction of | Input | | | | under high- |
| | sensitive | | | | | surface of | configuration | | | | temperature |
| Example | member | P/mol | Q/mass | | | developing | of driving | Background | Developing | | and high- |
| No. | No. | % | % | R | λ | roller | force | fogging | ghost | Banding | humidity |
| Example | 1 | 50% | 10% | 1.25 | 1.12 | Counter | RS input | A | A | A | A |
| 1 | | | | | | | | | | | |
| Example | 2 | 50% | 9% | 1.25 | 1.12 | Counter | RS input | A | A | A | A |
| 2 | | | | | | | | | | | |
| Example | 3 | 50% | 11% | 1.25 | 1.12 | Counter | RS input | A | A | A | B |
| 3 | | | | | | | | | | | |
| Example | 4 | 22% | 12% | 1.25 | 1.12 | Counter | RS input | A | A | A | B |
| 4 | | | | | | | | | | | |
| Example | 5 | 28% | 11% | 1.25 | 1.12 | Counter | RS input | A | A | A | B |
| 5 | | | | | | | | | | | |
| Example | 6 | 33% | 11% | 1.25 | 1.12 | Counter | RS input | A | A | A | A |
| 6 | | | | | | | | | | | |
| Example | 7 | 42% | 11% | 1.25 | 1.12 | Counter | RS input | A | A | A | A |
| 7 | | | | | | | | | | | |
| Example | 8 | 63% | 9% | 1.25 | 1.12 | Counter | RS input | A | A | A | A |
| 8 | | | | | | | | | | | |
| Example | 9 | 67% | 9% | 1.25 | 1.12 | Counter | RS input | A | A | A | A |
| 9 | | | | | | | | | | | |
| Example | 10 | 50% | 4% | 1.25 | 1.12 | Counter | RS input | A | A | A | B |
| 10 | | | | | | | | | | | |
| Example | 11 | 50% | 7% | 1.25 | 1.12 | Counter | RS input | A | A | A | A |
| 11 | | | | | | | | | | | |
| Example | 12 | 50% | 9% | 1.25 | 1.12 | Counter | RS input | A | A | A | A |
| 12 | | | | | | | | | | | |
| Example | 13 | 50% | 12% | 1.25 | 1.12 | Counter | RS input | A | A | A | A |
| 13 | | | | | | | | | | | |
| Example | 14 | 29% | 4% | 1.25 | 1.12 | Counter | RS input | A | A | B | B |
| 14 | | | | | | | | | | | |
| Example | 15 | — | 11% | 1.25 | 1.12 | Counter | RS input | A | A | B | C |
| 15 | | | | | | | | | | | |
| Example | 16 | — | 13% | 1.25 | 1.12 | Counter | RS input | A | A | C | C |
| 16 | | | | | | | | | | | |
| Example | 17 | — | 2% | 1.25 | 1.12 | Counter | RS input | A | A | B | C |
| 17 | | | | | | | | | | | |
| Example | 18 | — | 4% | 1.25 | 1.12 | Counter | RS input | A | A | B | C |
| 18 | | | | | | | | | | | |
| Example | 19 | — | 9% | 1.25 | 1.12 | Counter | RS input | A | A | B | C |
| 19 | | | | | | | | | | | |
| Example | 20 | — | 13% | 1.25 | 1.12 | Counter | RS input | A | A | B | C |
| 20 | | | | | | | | | | | |
| Example | 1 | 50% | 10% | 1.25 | 1.12 | Counter | D input | A | A | B | B |
| 21 | | | | | | | | | | | |
| Example | 1 | 50% | 10% | 1.20 | 1.08 | Counter | RS input | A | A | A | A |
| 22 | | | | | | | | | | | |
| Example | 1 | 50% | 10% | 1.30 | 1.17 | Counter | RS input | A | A | A | A |
| 23 | | | | | | | | | | | |
| Example | 1 | 50% | 10% | 1.40 | 1.26 | Counter | RS input | B | A | A | B |
| 24 | | | | | | | | | | | |
| Example | 1 | 50% | 10% | 1.50 | 1.35 | Counter | RS input | B | A | B | B |
| 25 | | | | | | | | | | | |
| Example | 1 | 50% | 10% | 1.20 | 1.08 | Counter | D input | A | A | B | B |
| 26 | | | | | | | | | | | |
| Example | 1 | 50% | 10% | 1.30 | 1.17 | Counter | D input | A | A | B | B |
| 27 | | | | | | | | | | | |
| Example | 1 | 50% | 10% | 1.40 | 1.26 | Counter | D input | B | A | B | B |
| 28 | | | | | | | | | | | |
| Example | 1 | 50% | 10% | 1.50 | 1.35 | Counter | D input | B | A | B | B |
| 29 | | | | | | | | | | | |
| Example | 10 | 50% | 4% | 1.40 | 1.26 | Counter | D input | B | A | B | B |
| 30 | | | | | | | | | | | |
| Example | 14 | 29% | 4% | 1.40 | 1.26 | Counter | D input | B | A | B | C |
| 31 | | | | | | | | | | | |
| Example | 21 | — | 12% | 1.25 | 1.12 | Counter | D input | A | A | B | C |
| 32 | | | | | | | | | | | |
| Example | 22 | — | 4% | 1.25 | 1.12 | Counter | D input | A | A | C | C |
| 33 | | | | | | | | | | | |
| Example | 22 | — | 4% | 1.40 | 1.26 | Counter | D input | B | A | C | C |
| 34 | | | | | | | | | | | |
| Example | 15 | — | 11% | 1.25 | 1.12 | Counter | D input | A | A | B | C |
| 35 | | | | | | | | | | | |
| Example | 15 | — | 11% | 1.40 | 1.26 | Counter | D input | B | A | B | C |
| 36 | | | | | | | | | | | |
| Example | 18 | — | 4% | 1.40 | 1.26 | Counter | D input | B | A | C | C |
| 37 | | | | | | | | | | | |
| Example | 23 | — | 4% | 1.40 | 1.26 | Counter | D input | B | A | C | C |
| 38 | | | | | | | | | | | |

TABLE 8

| | | | | | | Configuration | | | | | |
|---|---|---|---|---|---|---|---|---|---|---|---|
| | | | | | | of movement | | | | | Banding |
| | Photo- | | | | | direction of | Input | | | | under high- |
| | sensitive | | | | | surface of | configuration | | | | temperature |
| Example | member | P/mol | Q/mass | | | developing | of driving | Background | Developing | | and high- |
| No. | No. | % | % | R | λ | roller | force | fogging | ghost | Banding | humidity |
| Example | 24 | 50% | 11% | 1.25 | 1.12 | Counter | RS input | A | A | A | A |
| 39 | | | | | | | | | | | |
| Example | 25 | 50% | 10% | 1.25 | 1.12 | Counter | RS input | A | A | A | A |
| 40 | | | | | | | | | | | |
| Example | 26 | — | 12% | 1.25 | 1.12 | Counter | RS input | A | A | B | C |
| 41 | | | | | | | | | | | |
| Example | 27 | — | 11% | 1.25 | 1.12 | Counter | RS input | A | A | B | C |
| 42 | | | | | | | | | | | |
| Example | 28 | — | 13% | 1.25 | 1.12 | Counter | D input | A | A | B | C |
| 43 | | | | | | | | | | | |
| Example | 29 | — | 12% | 1.25 | 1.12 | Counter | D input | A | A | B | C |
| 44 | | | | | | | | | | | |
| Example | 30 | 38% | 14% | 1.25 | 1.12 | Counter | RS input | A | A | A | A |
| 45 | | | | | | | | | | | |
| Example | 31 | — | 17% | 1.25 | 1.12 | Counter | RS input | A | A | B | C |
| 46 | | | | | | | | | | | |
| Example | 32 | — | 18% | 1.25 | 1.12 | Counter | RS input | A | A | B | C |
| 47 | | | | | | | | | | | |
| Example | 33 | — | 17% | 1.25 | 1.12 | Counter | RS input | A | A | B | C |
| 48 | | | | | | | | | | | |
| Example | 34 | 50% | 10% | 1.25 | 1.12 | Counter | RS input | A | A | A | A |
| 49 | | | | | | | | | | | |
| Example | 35 | 50% | 10% | 1.25 | 1.12 | Counter | RS input | A | A | A | A |
| 50 | | | | | | | | | | | |
| Example | 36 | — | 12% | 1.25 | 1.12 | Counter | RS input | A | A | B | C |
| 51 | | | | | | | | | | | |
| Example | 37 | — | 12% | 1.25 | 1.12 | Counter | RS input | A | A | B | C |
| 52 | | | | | | | | | | | |
| Example | 38 | 50% | 9% | 1.25 | 1.12 | Counter | RS input | A | A | A | A |
| 53 | | | | | | | | | | | |
| Example | 39 | 50% | 9% | 1.25 | 1.12 | Counter | RS input | A | A | A | A |
| 54 | | | | | | | | | | | |
| Example | 40 | 50% | 8% | 1.25 | 1.12 | Counter | RS input | A | A | A | A |
| 55 | | | | | | | | | | | |
| Example | 41 | — | 11% | 1.25 | 1.12 | Counter | RS input | A | A | B | C |
| 56 | | | | | | | | | | | |
| Example | 42 | — | 11% | 1.25 | 1.12 | Counter | RS input | A | A | B | C |
| 57 | | | | | | | | | | | |
| Example | 43 | — | 9% | 1.25 | 1.12 | Counter | RS input | A | A | B | C |
| 58 | | | | | | | | | | | |
| Example | 44 | — | 11% | 1.25 | 1.12 | Counter | RS input | A | A | B | C |
| 59 | | | | | | | | | | | |
| Example | 45 | — | 9% | 1.25 | 1.12 | Counter | RS input | A | A | B | C |
| 60 | | | | | | | | | | | |
| Example | 46 | — | 6% | 1.25 | 1.12 | Counter | RS input | A | A | B | C |
| 61 | | | | | | | | | | | |
| Example | 47 | — | 8% | 1.25 | 1.12 | Counter | RS input | A | A | B | C |
| 62 | | | | | | | | | | | |
| Example | 48 | — | 5% | 1.25 | 1.12 | Counter | RS input | A | A | B | C |
| 63 | | | | | | | | | | | |
| Example | 49 | — | 9% | 1.25 | 1.12 | Counter | RS input | A | A | B | C |
| 64 | | | | | | | | | | | |

TABLE 9

| | | | | | | Configuration | | | | | |
|---|---|---|---|---|---|---|---|---|---|---|---|
| | | | | | | of movement | | | | | Banding |
| | Photo- | | | | | direction of | Input | | | | under high- |
| | sensitive | | | | | surface of | configuration | | | | temperature |
| Example | member | P/mol | Q/mass | | | developing | of driving | Background | Developing | | and high- |
| No. | No. | % | % | R | λ | roller | force | fogging | ghost | Banding | humidity |
| Comparative | 50 | 100% | 0% | 1.25 | 1.12 | Counter | RS input | B | B | D | D |
| Example 1 | | | | | | | | | | | |
| Comparative | 51 | — | 0% | 1.25 | 1.12 | Counter | RS input | B | B | D | D |
| Example 2 | | | | | | | | | | | |
| Comparative | 52 | — | 0% | 1.25 | 1.12 | Counter | RS input | B | B | D | D |
| Example 3 | | | | | | | | | | | |
| Comparative | 53 | — | 0% | 1.25 | 1.12 | Counter | RS input | B | B | D | D |
| Example 4 | | | | | | | | | | | |
| Comparative | 54 | — | 0% | 1.25 | 1.12 | Counter | RS input | B | B | D | D |
| Example 5 | | | | | | | | | | | |
| Comparative | 55 | 100% | 0% | 1.25 | 1.12 | Counter | RS input | B | B | D | D |
| Example 6 | | | | | | | | | | | |
| Comparative | 56 | — | 0% | 1.25 | 1.12 | Counter | RS input | B | B | D | D |
| Example 7 | | | | | | | | | | | |
| Comparative | 57 | — | 0% | 1.25 | 1.12 | Counter | RS input | B | B | D | D |
| Example 8 | | | | | | | | | | | |
| Comparative | 58 | — | 0% | 1.25 | 1.12 | Counter | RS input | B | B | D | D |
| Example 9 | | | | | | | | | | | |
| Comparative | 59 | — | 0% | 1.25 | 1.12 | Counter | RS input | B | B | D | D |
| Example 10 | | | | | | | | | | | |
| Comparative | 60 | — | 0% | 1.25 | 1.12 | Counter | RS input | B | B | D | D |
| Example 11 | | | | | | | | | | | |
| Comparative | 1 | 50% | 10% | 1.15 | 1.03 | Counter | RS input | B | D | D | D |
| Example 12 | | | | | | | | | | | |
| Comparative | 1 | 50% | 10% | 1.60 | 1.44 | Counter | RS input | D | B | D | D |
| Example 13 | | | | | | | | | | | |
| Comparative | 21 | — | 12% | 1.15 | 1.03 | Counter | RS input | B | D | D | D |
| Example 14 | | | | | | | | | | | |
| Comparative | 21 | — | 12% | 1.60 | 1.44 | Counter | RS input | D | B | D | D |
| Example 15 | | | | | | | | | | | |
| Comparative | 1 | 50% | 10% | 1.25 | 1.12 | With | RS input | D | D | D | D |
| Example 16 | | | | | | | | | | | |
| Comparative | 54 | — | 0% | 1.25 | 1.12 | With | RS input | D | D | D | D |
| Example 17 | | | | | | | | | | | |
| Comparative | 54 | — | 0% | 1.25 | 1.12 | With | D input | D | D | D | D |
| Example 18 | | | | | | | | | | | |
| Comparative | 54 | — | 0% | 1.60 | 1.44 | With | D input | D | D | D | D |
| Example 19 | | | | | | | | | | | |

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-075129, filed Apr. 28, 2023, Japanese Patent Application No. 2023-184117, filed Oct. 26, 2023, and Japanese Patent Application No. 2024-026847, filed Feb. 26, 2024, which are hereby incorporated by reference herein in their entirety.

What is claimed is:

1. A process cartridge being detachably attachable onto a main body of an electrophotographic apparatus,
the process cartridge comprising:
an electrophotographic photosensitive member;
a developing roller configured to develop an electrostatic latent image formed on a surface of the electrophotographic photosensitive member; and
a toner-supplying roller arranged in contact with the developing roller and configured to supply toner to the developing roller,
wherein the developing roller and the toner-supplying roller are configured so that a movement direction of a surface of the developing roller and a movement direction of a surface of the toner-supplying roller at a time of operation are opposite to each other at a contact position between the developing roller and the toner-supplying roller, and
the developing roller and the toner-supplying roller are rotated while R represented by the following formula (E1) satisfies 1.2≤R≤1.5:
R=V_{RS}/V_{D} (E1)
in the formula (E1),
V_{RS} represents an absolute value of a peripheral velocity [m/s] of the toner-suppling roller, and
V_{D} represents an absolute value of a peripheral velocity [m/s] of the developing roller, and
wherein the electrophotographic photosensitive member includes a surface layer containing a polycarbonate resin including a structural unit represented by the following formula (A1): 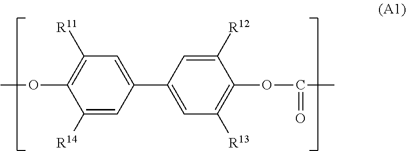
in the formula (A1), R¹¹ to R¹⁴ each independently represent a hydrogen atom or a methyl group.

2. The process cartridge according to claim 1, wherein the polycarbonate resin includes at least one kind of structural unit selected from the group consisting of: a structural unit represented by the following formula (A2); and a structural unit represented by the following formula (A3).

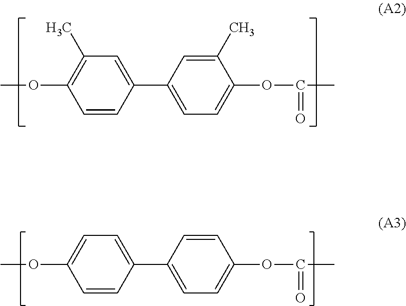

3. The process cartridge according to claim 1, wherein the polycarbonate resin further includes a structural unit represented by the following formula (A4).

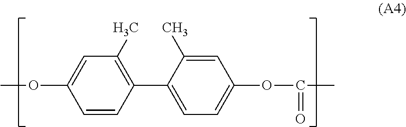

4. The process cartridge according to claim 2,
wherein the polycarbonate resin further includes a structural unit represented by the following formula (A4): 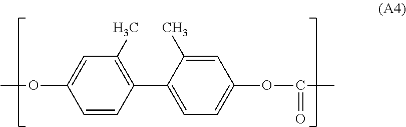
wherein a total ion chromatogram (TIC) obtained by subjecting a polymer component recovered from the surface layer to pyrolysis-gas chromatography-mass spectrometry under coexistence with tetramethylammonium hydroxide (TMAH) has a mass spectrum including components corresponding to m/z=242 and m/z=227, and
wherein a ¹H-nuclear magnetic resonance spectrum obtained by subjecting the polymer component to ¹H-nuclear magnetic resonance analysis in deuterated chloroform has peaks at 2.35±0.02 ppm and 2.40±0.02 ppm.

5. The process cartridge according to claim 3, wherein a ratio of a content of the structural unit represented by the formula (A4) with respect to a total of a content of the structural unit represented by the formula (A1) and the content of the structural unit represented by the formula (A4) in the surface layer is 30 to 70 mol %.

6. The process cartridge according to claim 1, wherein a content ratio of the polycarbonate resin including the structural unit represented by the formula (A1) with respect to a total mass of the surface layer in the surface layer is 5 to 20 mass %.

7. The process cartridge according to claim 1 further comprising:
a driving force-receiving portion configured to receive a driving force for driving the toner-supplying roller;
a first driving force-transmitting portion configured to transmit the driving force received by the driving force-receiving portion to the toner-supplying roller; and
a second driving force-transmitting portion configured to transmit a driving force generated by drive of the toner-supplying roller to the developing roller.

8. The process cartridge according to claim 7,
wherein the second driving force-transmitting portion includes a third driving force-transmitting portion, a fourth driving force-transmitting portion, and a fifth driving force-transmitting portion,
wherein the third driving force-transmitting portion is arranged in an end portion of a shaft body of the toner-supplying roller, and is configured to transmit the driving force generated by drive of the toner-supplying roller to the fourth driving force-transmitting portion,
wherein the fourth driving force-transmitting portion is configured to transmit a driving force to the fifth driving force-transmitting portion by being driven with the driving force received from the third driving force-transmitting portion, and
wherein the fifth driving force-transmitting portion is arranged in an end portion of a mandrel of the developing roller, and is configured to receive the driving force from the fourth driving force-transmitting portion to drive the developing roller.

9. The process cartridge according to claim 7, wherein when a radius of the developing roller is represented by r_{D} [mm], and a radius of the toner-supplying roller is represented by r_{RS} [mm], the toner-supplying roller, the second driving force-transmitting portion, and the developing roller are driven to be coupled so that λ represented by the following formula (E2) satisfies 1.2≤λ×r_{RS}/r_{D}≤1.5:
λ=ω_{RS}/ω_{D} Formula (E2)
in the formula (E2), ω_{RS} represents a rotational angular velocity [rad/s] of the toner-supplying roller, and OD represents a rotational angular velocity [rad/s] of the developing roller.

10. The process cartridge according to claim 1, wherein the R satisfies 1.2≤R≤1.3.

11. An electrophotographic apparatus comprising a process cartridge,
wherein the process cartridge is detachably attachable onto a main body of the electrophotographic apparatus,
wherein the process cartridge includes:
an electrophotographic photosensitive member;
a developing roller configured to develop an electrostatic latent image formed on a surface of the electrophotographic photosensitive member; and
a toner-supplying roller arranged in contact with the developing roller and configured to supply toner to the developing roller,
wherein the developing roller and the toner-supplying roller are configured so that a movement direction of a surface of the developing roller and a movement direction of a surface of the toner-supplying roller at a time of operation are opposite to each other at a contact position between the developing roller and the toner-supplying roller, and
the developing roller and the toner-supplying roller are rotated while R represented by the following formula (E1) satisfies 1.2≤R≤1.5:
R=V_{RS}/V_{D} (E1)
in the formula (E1),
V_{RS} represents an absolute value of a peripheral velocity [m/s] of the toner-suppling roller, and
V_{D} represents an absolute value of a peripheral velocity [m/s] of the developing roller, and
wherein the electrophotographic photosensitive member includes a surface layer containing a polycarbonate resin including a structural unit represented by the following formula (A1): 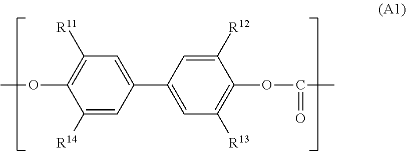
in the formula (A1), R¹¹ to R¹⁴ each independently represent a hydrogen atom or a methyl group.
